(19) United States
(12) Patent Application Publication
(10) Pub. No.: US 2025/0317724 A1
(43) Pub. Date: Oct. 9, 2025

(54) SYSTEMS, METHODS, AND DEVICES FOR DUAL STEER IN A WIRELESS NETWORK

(71) Applicant: Apple Inc., Cupertino, CA (US)

(72) Inventors: Vivek G. GUPTA, San Jose, CA (US); Haijing HU, Los Gatos, CA (US); Sridhar PRAKASAM, Fremont, CA (US)

(21) Appl. No.: 19/097,230

(22) Filed: Apr. 1, 2025

Related U.S. Application Data
(60) Provisional application No. 63/575,587, filed on Apr. 5, 2024.

(51) Int. Cl. H04W 8/08; H04W 8/06

(52) U.S. Cl. CPC H04W 8/08; H04W 8/065

(57) ABSTRACT

The techniques herein include solutions for dual steering across different 3rd generations partnership project (3GPP) networks. A device may have multiple subscriptions and be capable of dual steering. The device may register a user equipment (UE) with a first 3GPP network for dual steering and indicate a capability for dual steering. The first 3GPP network may register the UE for dual steering and provide the UE with rules and policies for dual steering. The rules and policies may be based on preferences, capabilities, and network subscriptions of the UE. The device may register another UE with a second 3GPP network for dual steering, and the first and second 3GPP networks may coordinate to associate the duel steering registrations at the first and second 3GPP networks. The device may proceed to engage in traffic steering and network switching based on the dual steering rules and policies.

### CROSS REFERENCE TO RELATED APPLICATIONS

This application claims the benefit of U.S. Provisional Application No. 63/575,587, filed Apr. 5, 2024, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. One of many aspects of developing such technologies include enabling UEs to connect to different networks.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example of dual steer in a wireless network according to one or more implementations described herein.

FIG. 4 is a diagram of an example of a 5th generation (5G) or new radio (NR) network architecture according to one or more implementations described herein.

FIG. 5 is a diagram of an example of a 4th generation (4G) or evolved packet core (EPC) network architecture according to one or more implementations described herein.

FIGS. 6-7 are diagrams of an example of a process for dual steer policy management according to one or more implementations described herein.

FIG. 8 is a diagram of an example of a 5G session management (5GSM) capability information element (IE) according to one or more implementations described herein.

FIG. 9 is a diagram of an example of a route selection descriptor (RSD) of a UE route selection policy (URSP) according to one or more implementations described herein.

FIG. 10 is a diagram of example of a UE route selection policy (URSP) rule according to one or more implementations described herein.

FIGS. 11-13 are diagrams of an example of a process for dual steer policy management according to one or more implementations described herein.

FIG. 14 is a diagram of an example of a process for session management function (SMF) and user plane function (UPF) interactions via policy function control protocol (PFCP) according to one or more implementations described herein.

FIG. 15 is a diagram of an example of IEs of a PFCP session establishment request according to one or more implementations described herein.

FIG. 16 is a diagram of an example of dual steer IEs of a PFCP session establishment request according to one or more implementations described herein.

FIG. 17 is a diagram of an example process for dual steer in a wireless network according to one or more implementations described herein.

FIG. 18 is a diagram of an example process for dual steer in a wireless network according to one or more implementations described herein.

FIG. 19 is a diagram of an example process for dual steer in a wireless network according to one or more implementations described herein.

FIG. 20 is a diagram of an example of components of a device according to one or more implementations described herein.

FIG. 21 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include enabling UEs to connect to different networks.

Currently available techniques fail to provide any, or adequate, solutions for enabling dual steer (also referred to as DualSteer, DualSteering, dual steering, etc.) across different 3rd generation partnership project (3GPP) networks. Dual steering may refer to a device with a single UE or two separate UEs being enabled to steer, switch, or split different traffic flows to different networks. The access networks may be terrestrial access networks, non-terrestrial access networks, or a combination thereof. The 3GPP access networks may correspond to one public land mobile network (PLMN), different PLMNs, or one non-public network (NPN). One or more of the techniques described herein provide solutions for enabling a UE to implement dual steering across different 3GPP networks.

Dual steering may also be referred to as DualSteering or DualSteer. A device capable of dual steering may be referred to as a dual steer device, a dual steer UE, etc. A dual steer device may be a single UE capable of non-simultaneous data transmission over the two networks, or separate UEs capable of simultaneous data transmission over the two networks. A dual steer device may, in a sense, be two UEs incorporated into a single physical device. From a user perspective, a dual steer device may be a single UE. From a network perspective, a dual steer device may be two UEs. For simplicity, a dual steer device (or DualSteer device) may be referred to herein as a dual steer UE, a UE capable of dual steering, etc. A UE registering for DualSteering, a UE engaged in DualSteering, and so one, may be part of a DualSteer device.

A UE capable of dual steering may have two subscriptions registered to two different 3GPP access networks. Each subscription may be uniquely identified by a different subscription permanent identifier (SUPI). A dual steer UE may have one subscriber identity module (SIM) for both SUPIs or a SIM for each SUPI (e.g., two SIMs). The SUPIs may be associated with one subscription profile from the same network operator, two permanent equipment identifiers (PEIs), and two international mobile equipment identity (IMEIs). A dual steer UE may register with a network using the same signaling as a non-dual steer UE, regardless of whether the dual steer UE registers with networks consecutively or simultaneously. A dual steer UE may perform steering or switching of application traffic across different access network connections using the two SUPIs. In some implementations, a dual steer UE may identify a network that supports dual steering and switching, and which pair of SUPIs or subscriptions belong to the same subscription profile registered to the network. A dual steer UE may appear as a single consolidated UE to upper layers (e.g., a higher layer operating system (HLOS), etc.).

From the perspective of the network, a dual steer device may appear as two separate UEs, regardless of whether the dual steer device may transmit over two networks simultaneously. The dual steer device may register with networks separately, and the network may identify the two SUPIs associated with the dual steer device. A unified data management (UDM) function, of a core network, may determine that an access and mobility management function (AMF) registration is the same for each access network connection of the dual steer UE, but ensure that the older or original registration context is maintained. The core network may generate appropriate rules to identify the two access paths of the dual steer device and to perform steering and switching between protocol data unit (PDU) sessions associated with each of the SUPIs/UEs.

A dual steer device may be capable of traffic steering and switching across 3GPP networks based on DualSteer rules, policies, and measurements. For example, a policy control function (PCF) may provide DualSteer rules to a UE of a dual steer device via a session management function (SMF) and/or AMF to route uplink (UL) traffic. The SMF may provide N4 interface rules to a user plane function (UPF) to indicate how downlink (DL) traffic is to be routed. A performance management function (PMF) may relay messages between the UE and UPF for round trip time (RTT) measurements over a corresponding access type. The AMF may use a DL network access stratum (NAS) transport message to deliver a rule or policy from the PCF to the UE. The UE may use a UL NAS transport message to acknowledge receipt of the rule or policy from the PCF when an acknowledgement (ACK) is requested.

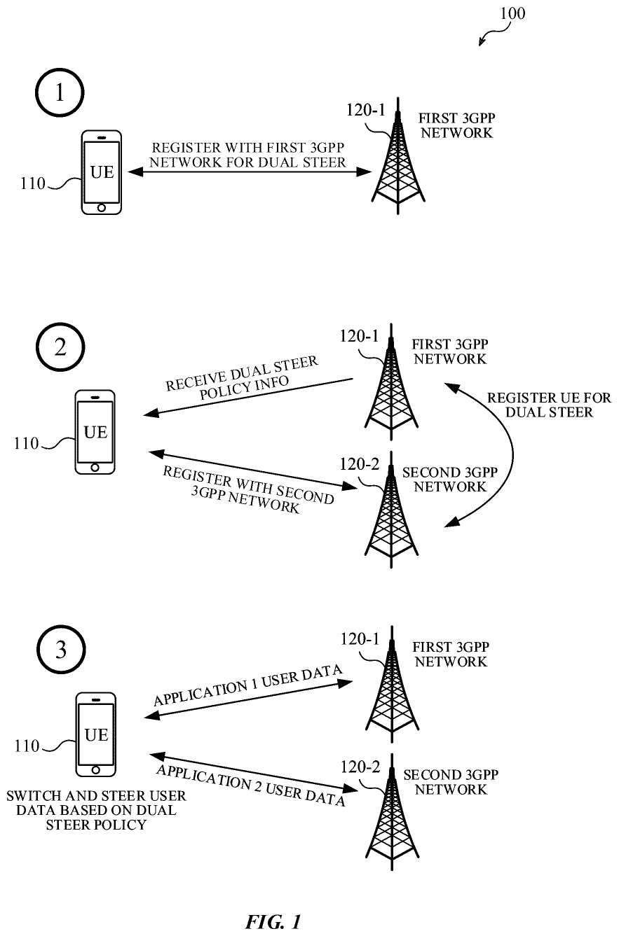

FIG. 1 is a diagram of an example of an overview 100 according to one or more implementations described herein. As shown, overview 100 may include UE 110 and a first 3GPP network 120-1. The first 3GPP network 120-1 may include a base station and a core network and may be connected to a PLMN. UE 110 may register with the first 3GPP network for dual steering (at 1). In response the first 3GPP network may provide UE 110 with rules and policy information about engaging in dual steering (at 2). UE 110 may also register with a second 3GPP network that is different than the first 3GPP network. In response, the first and second 3GPP networks may communicate with one another to associate the dual registrations of UE 110 for dual steering. Upon registering with both 3GPP networks, UE 110 may proceed to engage in dual steering based on the dual steer rules and policies received previously (at 3). This may include routing traffic from one application through the first 3GPP network and routing traffic from another application through a second 3GPP network. These and other features and examples are described in detail below, including the operations of several core network entities.

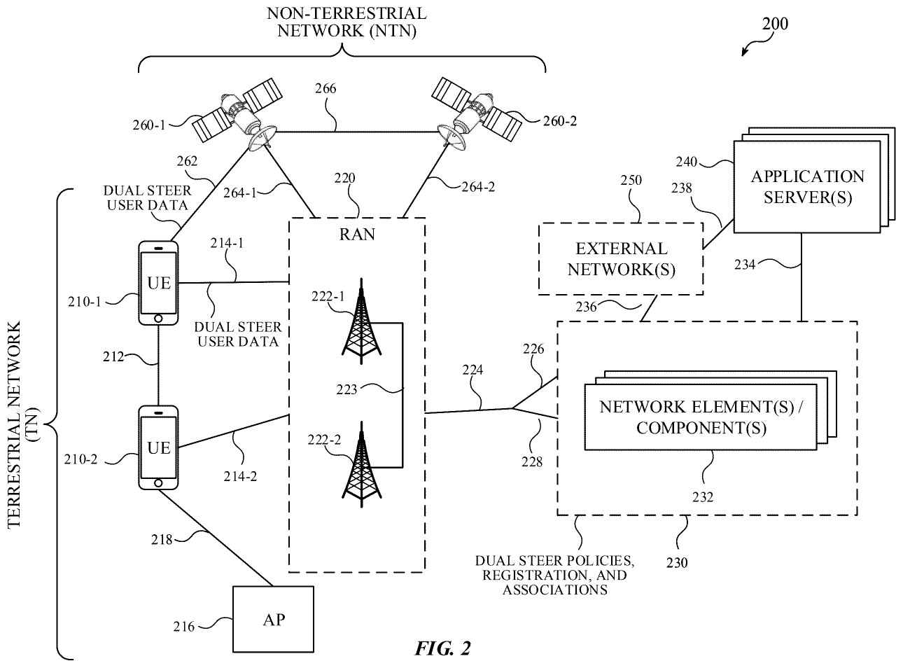

FIG. 2 is an example network 200 according to one or more implementations described herein. Example network 200 may include UEs 210-1, 210-2, etc. (referred to collectively as “UEs 210” and individually as “UE 210”), a radio access network (RAN) 220, a core network (CN) 230, application servers 240, external networks 250, and satellites 260-1, 260-2, etc. (referred to collectively as “satellites 260” and individually as “satellite 260”). As shown, network 200 may include a non-terrestrial network (NTN) comprising one or more satellites 260 (e.g., of a global navigation satellite system (GNSS)) in communication with UEs 210 and RAN 220.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210 may communicate with RAN node 222 to request SL resources. RAN node 222 may respond to the request by providing UE 210 with a dynamic grant (DG) or configured grant (CG) regarding SL resources. A DG may include a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). A network node may be referred to herein as a base station 222. In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells. A RAN node may generally be referred to herein as base station 222. Satellites 260 may operate as RAN nodes 222, with respect to UEs 210. As such, references herein to a base station, RAN node 222, etc., may involve implementations where the base station, RAN node 222, etc., is a terrestrial network (TN) node and also to implementation where the base station, RAN node 222, etc., is a NTN node (e.g., satellite 260).

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements (REs). Each resource block may comprise a collection of resource elements; in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), enhanced LAA (eLAA), and/or further eLAA (feLAA) mechanisms. In such implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

One or more of the techniques described herein may enable UE 210 to dual steer across different 3GPP networks. The UE may register with a first 3GPP network for dual steering and indicate a capability for dual steering. The first 3GPP network may register the UE for dual steering and provide the UE with rules and policies for dual steering. The rules and policies may be based on preferences, capabilities, and network subscriptions of UE 210. UE 210 may reregister with a second 3GPP network and indicate a capability to dual steer. The first and second 3GPP networks may coordinate to associate the duel steering registrations of UE 210 at the first and second 3GPP networks. UE 210 may proceed to engage in traffic steering and network switching based on the dual steering rules and policies. Many other aspects and examples are also described herein. Many other aspects and examples are also described herein.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN (5GC), and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network function virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

Satellites 260 may communicate with UEs 210 via service link or wireless interface 262 and/or RAN 220 via feeder links or wireless interfaces 264 (depicted individually as 264-1 and 264-2). In some implementations, satellite 260 may operate as a passive or transparent network relay node regarding communications between UE 210 and the terrestrial network (e.g., RAN 220). In some implementations, satellite 260 may operate as an active or regenerative network node such that satellite 260 may operate as a base station to UEs 210 (e.g., as a base station of RAN 220). In some implementations, satellites 260 may communicate with one another via a direct wireless interface (e.g., 266) or an indirect wireless interface (e.g., via RAN 220 using interfaces 264-1 and 264-2).

Additionally, or alternatively, satellite 260 may include a GEO satellite, LEO satellite, or another type of satellite. Satellite 260 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 260 may operate as bases stations (e.g., RAN nodes 222) with respect to UEs 210. As such, references herein to a base station, RAN node 222, etc., may involve implementations where the base station, RAN node 222, etc., is a terrestrial network node and implementation, where the base station, RAN node 222, etc., is a non-terrestrial network node (e.g., satellite 260). As described herein, UE 210 and base station 222 may communicate with one another, via interface 214, to enable enhanced power saving techniques.

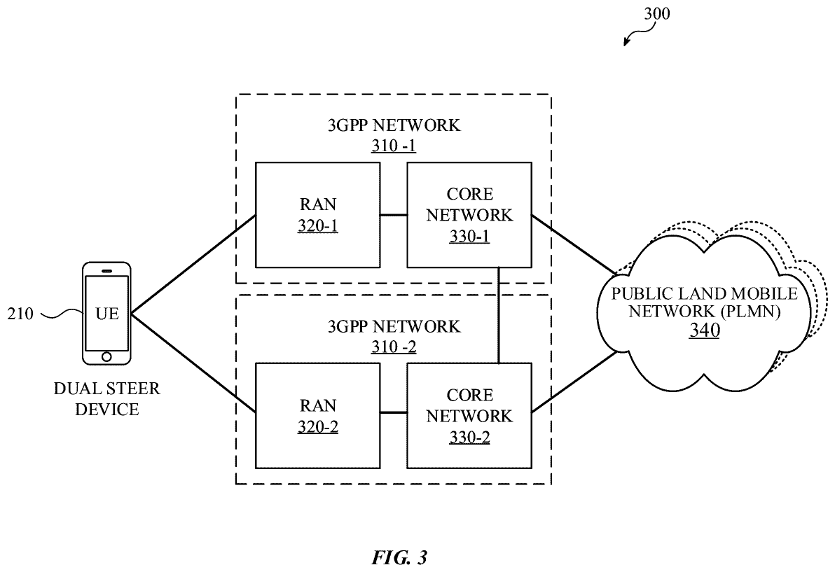

FIG. 3 is a diagram of an example 300 of dual steer in a wireless network according to one or more implementations described herein. As shown, example 300 may include UE 210, 3GPP network 310-1, 3GPP network 310-2, and PLMN 340. 3GPP network 310-1 and 3GPP network 310-2 each include a RAN (320-1 and 320-2) and a core network (330-1 and 330-2).

3GPP network 310-1 and 3GPP network 310-2 may include the same generation of 3GPP network or different generations of 3GPP network (e.g., a 4G or LTE network, a 5G network, a 6G network, or any combination thereof.). RAN 320-1 and 320-2 may include a terrestrial network, a non-terrestrial network, or any combination thereof. Core networks 330-1 and 330-2 may include an EPC, a 5GC, a 6G core network, or any combination thereof. 3GPP network 310-1 and 3GPP network 310-2 may connect to the same PLMN 340, which may be a home PLMN (HPLMN) for UE 210.

As shown, UE 210 may implement dual steer techniques, as described herein, to engage in traffic switching and steering across different 3GPP networks 320-1 and 320-2. This may be enabled by UE route selection policies (URSP) and enhanced route selection descriptors (RSD) stored and implemented UE 210 and different core network entities. For example, URSPs may be provided to UE 210 by a core network entity and UE network registration context may be maintained by communications between entities of core network 330-1 and 330-2. Dual steering, as described herein, may be implemented after UE 210 completes PLMN selection and registration, such that the duel steering techniques described herein may not affect existing PLMN selection and registration mechanisms.

In some implementations, a dual stere UE 210 may support several dual steer scenarios, and URSP rules and policies, as described herein, may be applied to each scenario. For example, one UE of the dual steer UE 210 may register directly with a home PLMN (HPLMN). The other UE of the dual steer UE 210 may register to a visiting PLMN (VPLMN) and may perform home routing to the HPLMN. In another example, one UE of the dual steer UE 210 may register to a RAN 220 of an HPLMN, and the other UE of the dual steer UE 210 may register to another RAN 220 of the HPLMN. In yet another example, one UE of the dual steer UE 210 may register to a 5GS HPLMN and the other UE of the dual steer UE 210 may register to an EPS HPLMN.

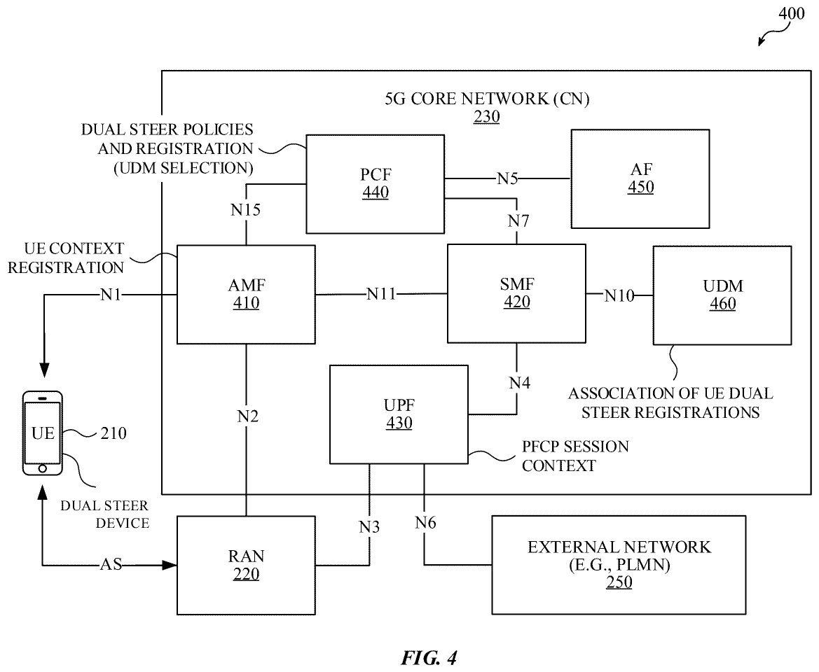

FIG. 4 is a diagram of an example of a 5G or NR network architecture 400 according to one or more implementations described herein. As shown, example network architecture 400 may include UE 210, RAN 220, CN 230, and external network 250. RAN 220 may include base station 222 and/or one or more other types of APs 216. CN 230 may include access and mobility management function (AMF) 410, session management function (SMF) 420, user plane function (UPF) 430), policy control function (PCF) 440, application function (AF) 450, and unified data management (UDM) node 460.

AMF 410, SMF 420, UPF 430, PCF 440, AF 450, and UDM node 460 may be functions of CN 230 and may be implemented by one or more servers in a centralized or distributed networking environment, which may include one or more network virtualization functions (NVF). External network 250 may include a data network that includes one or more application servers, the Internet, another telecommunications network, and/or another type of network. In some implementations, example network architecture 400 may include one or more additional, alternative, and/or differently arranged functions, interfaces, or other features than those shown in FIG. 4.

AMF 410 may communicate with RAN 220 via an N2 interface and UE 210 via an N1 interface. AMF 410 may manage authentication, registration, and other functionalities relating to UEs 210 accessing a telecommunication mobile network. AMF 410 may handle handovers, paging, and other functionality regarding the mobility and communications of UEs 210. AMF 410 may also provide security functionality for authenticating and authorizing UEs 210. AMF 410 may communicate with SMF via an N11 interface, with PCF 440 via an N15 interface, and with UPF 440 via an N4 interface.

While not shown, network architecture 400 may also include an authentication server function (AUSF). The AUSF may operate to authenticate UEs 210 based on credentials from UE 210. The AUSF may receive the credentials from AMF 410 via an N12 interface. AUSF may cooperate with UDM 460, via an N13 interface, to obtain authentication vectors and determine whether UE 210 is authorized to access the network. Upon verifying UE 210, the AUSF may send an authentication response or message to AMF 410. The authentication response may cause or enable AMF 410 to proceed with registering UE 210 and/or other functionalities relating to UE 210 accessing the network

SMF 420 may provide PDU session management. To do so, SMF 420 may collect information related to managing a PDU session from various network components (e.g., UPF 430, PCF 440, AF 450, etc.) and control or orchestrate the network components based on a request from AMF 410. SMF 420 may be responsible for establishing, maintaining, and terminating user sessions in CN 230. SMF 420 may manage user plane (UP) resources and interact with UPF 430 to ensure that data packets are correctly routed and forwarded.

SMF 420 may receive PDU session establishment and/or session modification request from UE 210. The request may include an indication for assistance with a UL PDU set identification. The request may also indicate a real-time transport protocol (RTP) header extension and/or transport layer protocol corresponding to the requested assistance. SMF 420 may determine whether a protocol description, corresponding to the request, has been provided by PCF 440 and/or AF 450. The protocol description may include information about the RTP header extensions and/or other protocol features used by an application, and in turn, enable UE 210 to identify PDU sets from UL packets. The protocol description may also, or alternatively, include information about one or more other types of transport layer protocols and/or protocol features used by an application, such that UE 210 may identify PDU sets from UL packets based on how the application uses the transport layer protocol.

SMF 420 may include PDU set protocol descriptions, QoS profiles and parameters, quality flow identifiers (QFIs), and/or one or more additional or alternative types of information to, for example, enable UL PDU sets of a given application or service to be appropriately identified. For example, AF 450 may include protocol descriptions for different types of applications and services supported by the network, such as XR applications and/or XRM applications and services. The protocol descriptions may include information to enable UE 210, base stations 222, and other devices to identify PDU sets within a service data flow. SMF 420 may receive the protocol descriptions from AF 450 via PCF 440, and may provide the protocol descriptions to UE 210, RAN 220, UPF 430, and/or one or more of the devices or entities described herein. In some implementations, the protocol descriptions provided by SMF 420 may be based, at least in part, on rules received from PCF 440. SMF 420 may provide N4 rules to UPF 430, which may indicate how DL traffic is to be routed.

UPF 430 may communicate with RAN 220 via an N3 interface, PCF 440 via an N7 interface, and SMF 420 via an N11 interface, which may be routed through RAN 220. UPF 430 may operate as a point of connection for PDU sessions between RAN 220 and external data network 250 (e.g., the Internet, another telecommunication network, etc.) via interface N6. UPF 430 may also provide support for packet routing, forwarding, and inspection. UPF 430 may provide for user plane rule enforcement, QoS handling, UL/DL rate enforcement, and service data flow (SDF) to QoS flow mapping. UPF 430 may communicate with SMF 420 via an N4 interface and with RAN 220 via an N3 interface.

UPF 430 (and/or another function of CN 230 or RAN 220) may monitor and measure a network load, link quality, data flow quality, and/or another type of characteristic relating to the service quality of a data flow associated with UE 210 and RAN 220. UPF 430 and/or another function of CN 230 or RAN 220 may compare the monitored conditions and measurements to one or more types of network service thresholds and may inform RAN 220 (e.g., base station 222) when the monitored conditions and measurements exceeds a corresponding threshold. As described herein, this may cause or prompt RAN 220 to RAN 220 to switch from a CG associated with one quality level (e.g., quality level X) to a CG associated with another quality level (e.g., quality level Y).

PCF 440 may provide policy control and flow-based control functionalities. PCF 440 may include and provide policy charging and control (PCC) rules for applications, data flows, PDU sets, gating, QoS, etc., to SMF 420. PCF 440 may also provide access and mobility management policies to AMF 410. PCF 440 may communicate with SMF 420 via an N7 interface and with AMF 410 via an N15 interface. PCF 440 may provide traffic steering and switching rules across multiple 3GPP networks to UE 210 via SMF 420/AMF 410 to route UL traffic.

UE 210 may send and receive information from RAN 220 via an access stratum (AS) interface. UE 210 may also send and receive PDU set information (e.g., protocol descriptions for PDU set information) from SMF 420. QoS flow profiles and PDU set protocol descriptions may also be configured from SMF 420 to RAN 220 and UE 210. Each QoS flow profile and/or PDU set protocol description may be associated with a set of QoS parameters that may be part of a QoS profile stored by RAN 220 and updated by AMF 410. Examples of QoS parameters may include a resource type, packet delay budget (PDB), quality flow identifier (QFI), packet error rate (PER), averaging window, and more. AMF 410 may provide UE 210 with QoS rules during a PDU session via a non-access stratum (NAS) protocol or interface.

AF 450 may include a network function configured to manage traffic and QoS assignments, through interaction with the policy elements. AF 450 may expose an application layer for interaction with 5G network functions (NFs) and network resources. AF 450 may reside in a control plane of a 5G service-based architecture (SBA), and AF 450 may function to access a network repository function (NEF) for retrieving resources, interacting with PCF 440 via an N5 interface, enabling policy control, traffic routing for applications, and providing application services to subscribers.

UDM node 460 may handle subscription-related information to support the handling of communication sessions. UDM node 460 may store subscription data of UE 210, which may be communicated between the UDM node 460 and the AMF 410 via an N8 interface (not shown). UDM node 460 may communicate with SFM 420 via an N10 interface. UDM node 460 may include two parts, an application functional entity (FE) and a unified data repository (UDR). The UDR may store subscription data and policy data for UDM node 460 and PCF 440, and/or structured data for exposure and application data (including packet flow descriptions (PFDs) for application detection and requested information). UDM node 460 may include a UDM-FE, which may process credentials, perform location management, subscription management, and so on. The UDM-FE may also access subscription information stored in the UDR and perform authentication credential processing, user identification handling, access authorization, registration/mobility management, and subscription management.

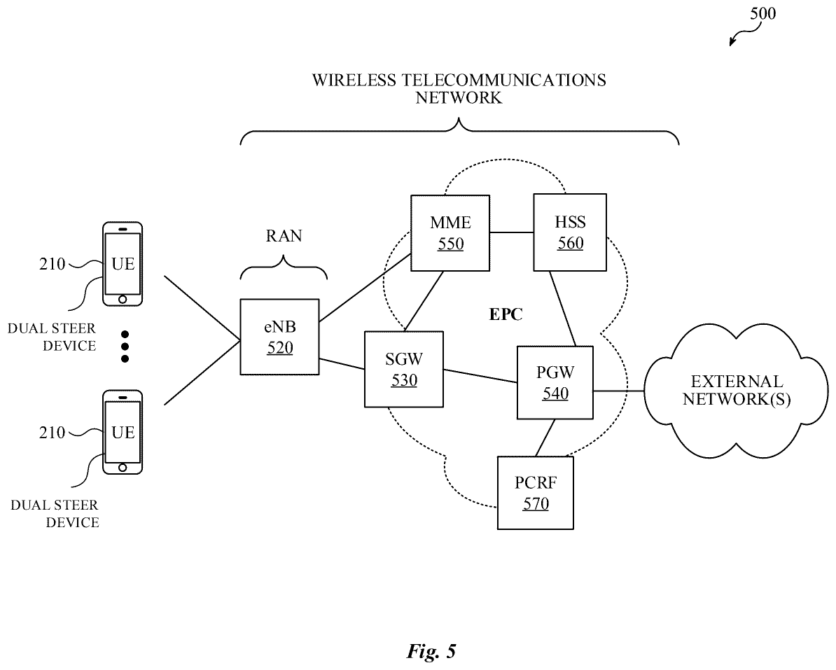

FIG. 5 illustrates an example 500 of a 4G or EPC network architecture in which systems and/or methods described herein may be implemented. Example 500 may include UEs 210, a wireless telecommunications network, and an external network. The wireless telecommunications network may include an Evolved Packet System (EPS) that includes a Long-Term Evolution (LTE) network and/or an evolved packet core (EPC) network that operates based on a 3rd Generation Partnership Project (3GPP) wireless communication standard. The LTE network may be or may include radio access networks (RANs) that include one or more base stations, some or all of which may take the form of enhanced Node Bs (eNBs) 520, via which UEs 210 may communicate with the EPC network.

The EPC network may include Serving Gateway (SGW) 530, PDN Gateway (PGW) 540, Mobility Management Entity (MME) 550, Home Subscriber Server (HSS) 560, and/or Policy and Charging Rules Function (PCRF) 570. As shown, the EPC network may enable UEs 210 to communicate with an external network, such as a Public Land Mobile Networks (PLMN), a Public Switched Telephone Network (PSTN), and/or an Internet Protocol (IP) network (e.g., the Internet).

UE 210 may be a dual steer device. As such, UE 210 may implement dual steering by connecting to different 3GPP networks, which may include one or more 4G networks, 5G networks, 6G networks, and so on. As such, one or more of the dual steer techniques, described herein, may be implemented by UE 210 and one or more of the entities of the EPC.

eNB 520 may include one or more network devices that receives, processes, and/or transmits traffic destined for and/or received from UE 210 (e.g., via an air interface). eNB 520 may be connected to a network device, such as site router, that functions as an intermediary for information communicated between eNB 520 and the EPC. As shown, eNB 520 may include an error correction application that enables eNB 520 to perform one or more of the techniques described herein. For example, the error correction application may enable eNB 520 to monitor network conditions (such as network activity, network congestion, physical resource block (PRB) utilization, etc.) and implement an error correction policy based on the network conditions. The error correction policy may provide instructions for implementing error correction procedures (e.g., retransmitting information) based on factors, such as network resource availability and service requirements associated with failed transmissions.

SGW 530 may aggregate traffic received from one or more eNBs 520 and may send the aggregated traffic to an external network or device via PGW 540. Additionally, SGW 530 may aggregate traffic received from one or more PGWs 540 and may send the aggregated traffic to one or more eNBs 520. SGW 530 may operate as an anchor for the user plane during inter-eNB handovers and as an anchor for mobility between different telecommunication networks. PGW 540 may include one or more network devices that may aggregate traffic received from one or more SGWs 530 and may send the aggregated traffic to an external network. PGW 540 may also, or alternatively, receive traffic from the external network and may send the traffic toward UE 210 (via SGW 530 and/or eNB 520).

MME 550 may include one or more computation and communication devices that act as a control node for eNB 520 and/or other devices that provide the air interface for the wireless telecommunications network. For example, MME 550 may perform operations to register UE 210 with the wireless telecommunications network, to establish bearer channels (e.g., traffic flows) associated with a session with UE 210, to hand off UE 210 to a different eNB, MME, or another network, and/or to perform other operations. MME 550 may perform policing operations on traffic destined for and/or received from UE 210.

HSS 560 may include one or more devices that may manage, update, and/or store, in a memory associated with HSS 560, profile information associated with a subscriber (e.g., a subscriber associated with UE 210). The profile information may identify applications and/or services that are permitted for and/or accessible by the subscriber; a Mobile Directory Number (MDN) associated with the subscriber; bandwidth or data rate thresholds associated with the applications and/or services; and/or other information. The subscriber may be associated with UE 210. Additionally, or alternatively, HSS 560 may perform authentication, authorization, and/or accounting operations associated with the subscriber and/or a communication session with UE 210.

PCRF 570 may receive information regarding policies and/or subscriptions from one or more sources, such as subscriber databases and/or from one or more users. PCRF 570 may provide these policies to PGW 540 or another device so that the policies can be enforced. As depicted, in some implementations, PCRF 570 may communicate with PGW 540 to ensure that charging policies are properly applied to locally routed sessions within the telecommunications network. For instance, after a locally routed session is terminated, PGW 540 may collect charging information regarding the session and provide the charging information to PCRF 570 for enforcement.

The quantity of devices and/or networks, illustrated in FIG. 5, is provided for explanatory purposes only. In practice, example 500 may include additional devices and/or networks; fewer devices and/or networks; different devices and/or networks; or differently arranged devices and/or networks than illustrated in FIG. 5. For example, while not shown, example 500 may include devices that facilitate or enable communication between various components shown in example 500, such as routers, modems, gateways, switches, hubs, etc. Alternatively, or additionally, one or more of the devices of example 500 may perform one or more functions described as being performed by another one or more of the devices of example 500. Additionally, the devices of example 500 may interconnect with each other and/or other devices via wired connections, wireless connections, or a combination of wired and wireless connections. In some implementations, one or more devices of example 500 may be physically integrated in, and/or may be physically attached to, one or more other devices of example 500. Also, while “direct” connections may be shown between certain devices in FIG. 5, some of said devices may, in practice, communicate with each other via one or more additional devices and/or networks.

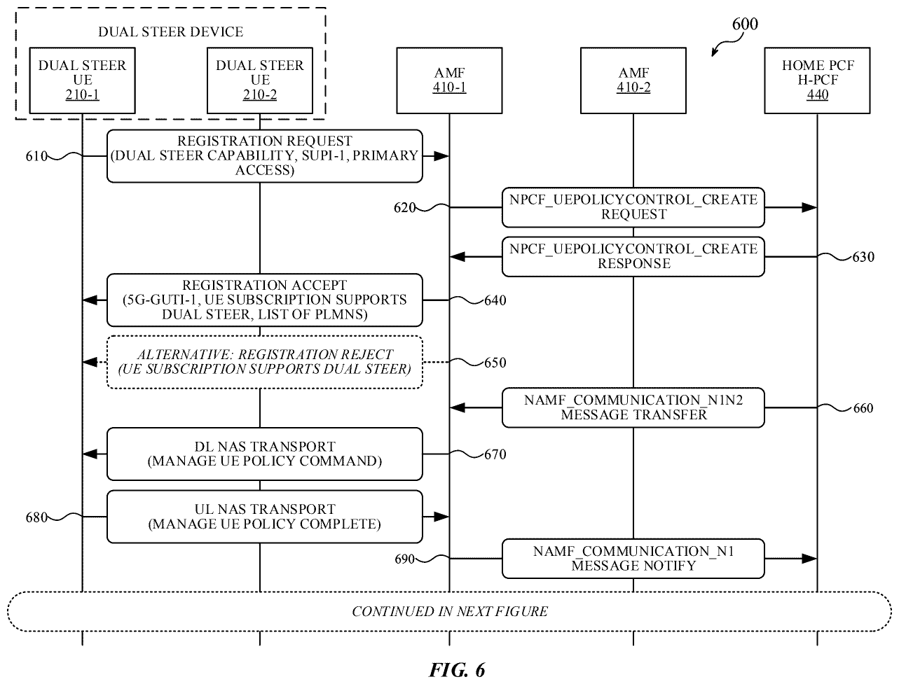

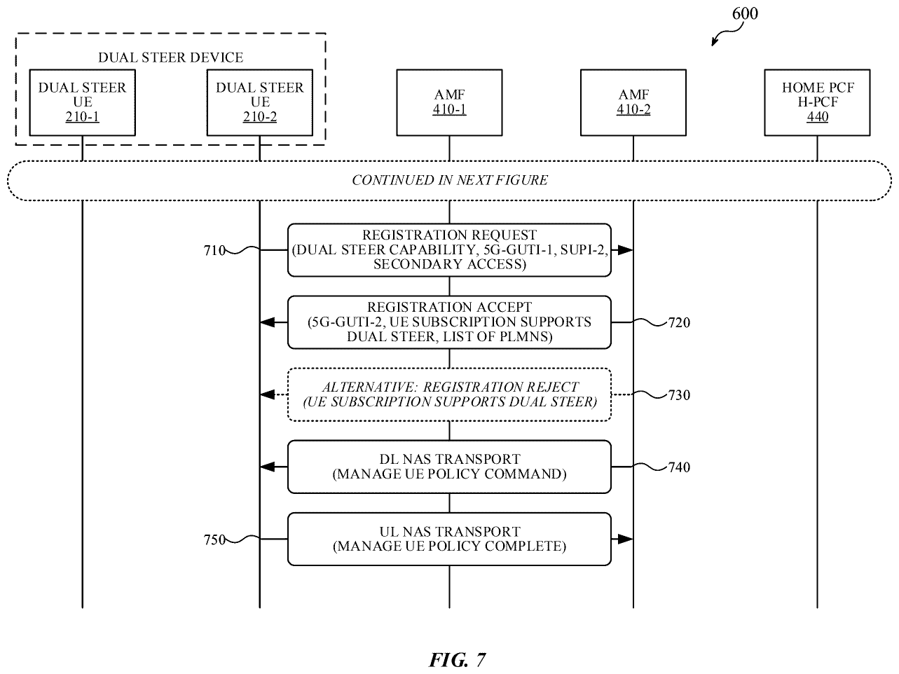

FIGS. 6-7 are diagrams of an example of a process 600 for dual steer policy management according to one or more implementations described herein. As shown, process 600 may include a dual steer device (represented as UE 210-1 and UE 210-2), AMF 410-1, AMF 410-2, and home PCF (H-PCF) 440. The dual steer device may be represented as UE 210-1 and UE 210-2 as the dual steer device may have two SUPIs. As described above, a SUPI may correspond to a subscription for service registered with a 3GPP network. As such, UE 210-1 may refer to the dual steer device operating under one SUPI registered with one 3GPP network, and UE 210-2 may refer to the dual steer device operating under another SUPI of another 3GPP network.

Similarly, AMF 410-1 and AMF 410-2 may refer to AMFs of different 3GPP networks. The SUPI of UE 210-1 may correspond to the 3GPP network of AMF 410-1. The SUPI of UE 210-2 may correspond to the 3GPP network of AMF 410-1. H-PCF 440 may represent a PCF associated with a home PLMN (HPLMN) of the dual steer device. For purposes of explaining process 600, assume that H-PCF 440 corresponds to primary or home network of the dual steer device, and that the primary home network corresponds to the SUPI of UE 210-1 and AMF 410-1.

Generally, Dual steer UE 210-1 may register on first access (e.g., a primary access). When a new application is activated the dual steer UE 210-1 may evaluate URSP rules and selects the URSP rule/RSD with new RAT/CN preference and may apply that to traffic associated with PDU session. URSP rules may also be updated using UCU procedure. dual steer UE 210-2 may register with a second access (e.g., a secondary access).

UE 210-1 may register with a first or primary 3GPP network and may perform a normal PLMN selection process to select the PLMN for registration. As shown, process 600 may include UE 210-1 communicating a registration request to AMF 410-1 (at 610). The registration request may include dual steer capability information, a SUPI (e.g., SUPI-1), and an indication of primary access. The registration request indicating dual steering may inform the network that the UE is capable of dual steering and, for example, that registration and context setup for UE 210-1 may later include an additional registration and context for UE 210-2. The registration request indicating SUPI-1 may enable the receiving network to register UE 210-1 for service consistent with a subscription associated with SUPI-1. The registration request indicating primary access may cause the receiving network (e.g., AMF 410-1) to handle the request in a different manner than a request for secondary access (e.g., by obtaining steering rules and policies associated with SUPI-1 and providing the duel steering rules and policies to UE 210-1).

AMF 410-1 may communicate with one or more other core network entities to verify that UE 210-1 has an appropriate subscription and credentials. AMF 410-1 may also create a session context for UE 210-1, which may include marking the access request and session as primary access for paging, mobile terminated (MT) calls, and other purposes. AMF 410-1 may establish a policy association between UE 210-1 and H-PCF 440 by sending H-PCF 440 a UE policy association creation request message (e.g., an Npcf_UEPolicyControl_Create_Request) message (at 620). H-PCF 440 may acknowledge and create the requested association, and respond accordingly to AMF 410-1 (e.g., via an Npcf_UEPolicyControl_Create_Response) (at 630).

AMF 410-1 may send a registration accept message to UE 210-1 (at 640). The registration accept message may include a 5G globally unique temporary identifier (e.g., 5G-GUTI-1) corresponding to the registration. A 5G-GUTI may include a temporary identity that does not have a fixed association with a specific subscriber or device. The use of a temporary identity may help improve privacy, and AMF 410-1 may change an allocated 5G-GUTI at any time. The registration accept message may notify UE 210-1 that the network supports dual steer functionality in general and the subscription of UE 210-1 for dual steer services. The network optionally includes list of PLMNs supported for each access technology based on the UE subscription. In some implementations, when UE 210 is not registered with the network, AMF 410-1 may send UE 210-1 a registration rejection message, which may include an indication of whether the subscription supports dual steer service (at 650).

H-PCF 440 may determine URSP rules for UE 210-1 and may send the URSP rules to AMF 410-1 (e.g., via a Namf_Communication_N1N2MessageTransfer message (at 660). The URSP rules may be applicable for dual steering relative to the home network of UE 210-1 and other networks (e.g., secondary networks) accessed by the dual steer device (e.g., via UE 210-2). In some implementations, URSP rules may be provided through only the primary access network. In such implementations, H-PCF 440 may be configured to reconcile and provide an appropriate set of rules for both access networks. In other implementations, URSP rules may be provided through both the primary and secondary access networks. When the dual steer device receives URSP rules from both the primary and secondary access networks, the dual steer device may use one set of URSP rules (e.g., the URSP rules from the primary network, the most recent URSP rules received, etc.).

AMF 410-1 may respond by sending the URSP rules to UE 210-1 via a DL NAS transport message (at 670). The URSP rules may be sent as a manage UE policy command message or IE. UE 210-1 may receive the message from AMF 410-1 and respond by sending AMF 410-1 a UL NAS transport message (at 680). This may include a manage UE policy complete message or IE and may include an indication or confirmation of the URSP rules having been received. AMF 410-1 may respond by sending H-PCF 440 a confirmation message of the URSP rules having been received (e.g., a Namf_Communication_N1N2MessageNotify message) (at 690).

Referring to FIG. 7, process 600 may also include the dual steer device using UE 210-2 to connect and register with a secondary network via AMF 410-2. The operations for doing so may be analogous to those described above with reference to UE 210-1 registering with a primary network via AMF 410-1. When a new application is activated by the dual steer device, the device may evaluate the URSP rules and select the URSP rule and RSD according to a corresponding RAT and/or CN preference that applies to traffic associated with a PDU session of the application.

UE 210-2 may register on a secondary 3GPP network using SUPI-2. UE 210-2 may perform a normal PLMN selection process to select the PLMN for registration. UE 210-2 may communicate a registration request to AMF 410-2 (at 710). The registration request may include dual steer capability information, the 5G-GUTI-1 received from AMF 410-1, a SUPI (e.g., SUPI-2), and an indication of secondary access. AMF 410-2 may retrieve UE subscription information from UDM 460 (not shown) and may verify whether UE 210-2 has a dual steer subscription. AMF 210-2 may retrieve the UE context already created by the primary network (using 5G-GUTI-1) as part of registration request on first access. If UE has appropriate subscription and credentials, AMF 410-2 may create a context for UE 210-2 in the secondary network. The secondary network may mark this access as SecondaryAccess for paging UE 210-2, MT calls, and other purposes. AMF 410-2 may establish a policy association between UE 210-2 and H-PCF 440. AMF 410-2 may also send a registration accept message to UE 210-2 (block 720). The message may include a 5G-GUTI-2 corresponding to this registration, a notification that the network supports dual steer services, and that UE 210-2 has a subscription for dual steer services with the secondary network. The message may include network also include list of updated PLMNs supported for each access technology based on UE subscription. In some implementations, when UE 210 is not registered with the secondary network, AMF 410-2 may send UE 210-2 a registration rejection message, which may include an indication of whether the subscription supports dual steer service (at 730).

In some implementations, H-PCF 440 may send the URSP rules to UE 210-2 via AMF 410-2. In such a scenario, AMF 420-2 may receive the URSP rules from H-PCF 440 or another entity of the primary network. AMF 410-2 may send the URSP rules to UE 210-2 via a DL NAS transport message (at 740). The URSP rules may be sent as a manage UE policy command message or IE. In some implementations, the manage UE policy command message may indicate that the URSP rules previously received by UE 210-1 are also applicable to UE 210-2. UE 210-2 may receive the message from AMF 410-2 and respond by sending AMF 410-2 a UL NAS transport message (at 750). This may include a manage UE policy complete message or IE, which may include an indication or confirmation of the URSP rules having been received.

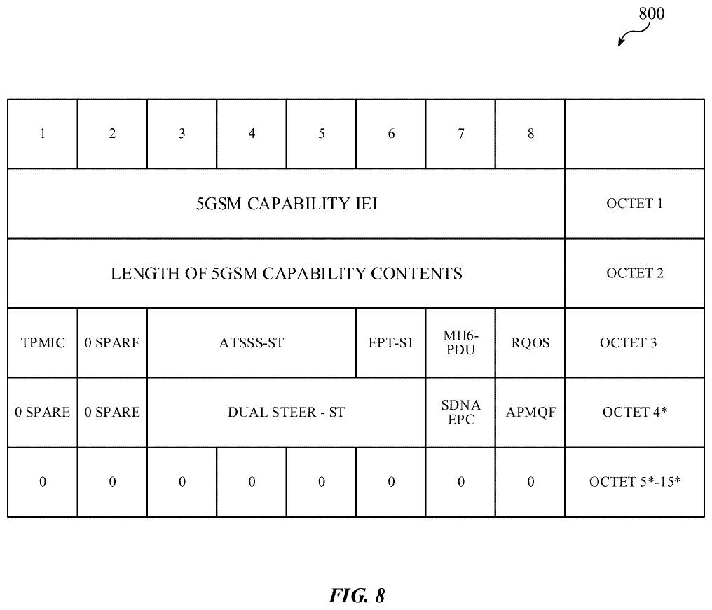

FIG. 8 is a diagram of an example of a 5G session management (5GSM) capability information element (IE) 800 according to one or more implementations described herein. UE 210 may send a registration request to AMF 410. The request may include an indication of UE 210 being capable of dual steering. 5GSM capability IE 800 may be an example of such an indication. Generally, 5GSM capability IE 800 may indicate UE capability related to the PDU session management. 5GSM capability IE 800 may be a type 4 IE with a minimum length of 3 octets and a maximum length of 15 octets.

5GSM capability IE 800 may indicate dual steer functionality in octet 4 from bits 3-6. A “0” may indicate that dual steering is not supported. A “1” may indicate that dual steering is supported with any steering mode allowed by lower layers (e.g., DualSteer-LL). A “2” may indicate support for that multi-path (MP) TCP (MPTCP) functionality with any steering mode and DualSteer-LL functionality with only active-standby steering mode. A “3” may indicate support for MPTCP functionality with any steering mode and DualSteer-LL functionality with any steering mode allowed for DualSteer-LL. A “4” may indicate support for multi-path QUIC (MPQUIC) functionality with any steering mode and DualSteer-LL functionality with only active-standby steering mode. “QUIC” may refer to an encrypted connection-oriented protocol that operates at the Transport Layer, or Layer 4, in the open system interconnection (OSI) model.

A “5” may indicate support for MPQUIC functionality with any steering mode and DualSteer-LL functionality with any steering mode allowed for DualSteer-LL. A “6” may indicate support for MPTCP functionality with any steering mode, MPQUIC functionality with any steering mode and DualSteer-LL functionality with only active-standby steering mode. A “7” may indicate support for MPTCP functionality with any steering mode, MPQUIC functionality with any steering mode and DualSteer-LL functionality with any steering mode allowed for DualSteer-LL. All other values may be reserved. 5GSM capability IE 800 may also include other types of fields and parameters represented in FIG. 8 as TPMIC, ATSSS-ST (Access Traffic Splitting Switching Steering—Steering), EPT-S1 MH6-PDU, RqoS (Reflective QoS), SDNA EPC (Enhanced Packet Core), APMQF, and more.

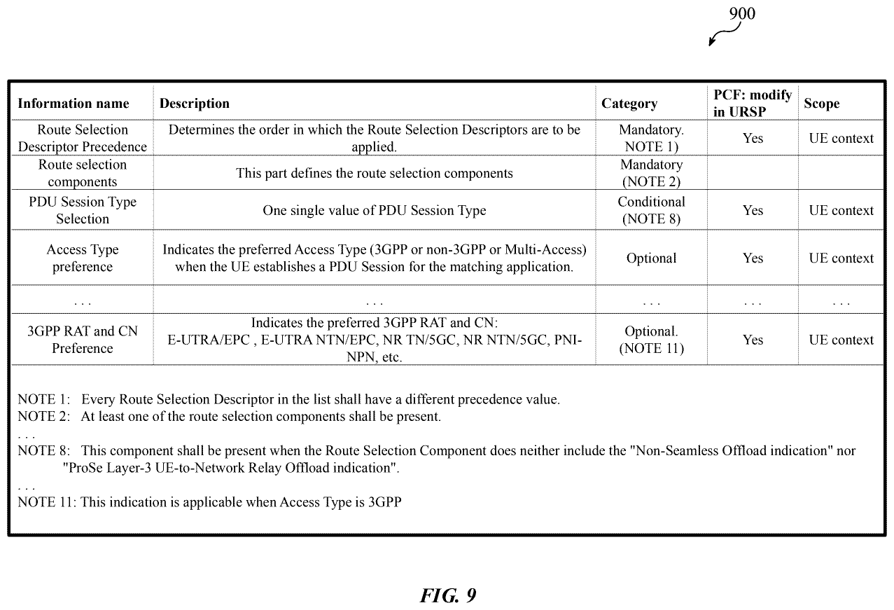

FIG. 9 is a diagram of example of an RSD 9000 of a URSP according to one or more implementations described herein. RSD 9000 may include multiple information types or names, corresponding descriptions, categories, and indication of whether PCF 440 is permitted to modify the corresponding information in a URSP, and a corresponding scope. The types of information include a route selection descriptor precedence, route selection components, PDU session type selection, access type preference, and a 3GPP RAT and CN preference.

H-PCF 440 may preform UE policy coordination may provision the URSP via a 5G system (5GS) and/or EPS. Policies may be delivered over a primary 3GPP access network and/or a secondary 3GPP access network. When policies are delivered over both 3GPP access networks, UE 210 may store the policies as they are received from H-PCF 440 and apply them. H-PCF 440 may take care of delivering dual steer policies applicable for both accesses.

UE 210 may use a URSP may be used to steer the traffic in different PDU sessions. URSP rules may be used for a certain UEs after the UE has done PLMN selection and registration. In a dual steer scenario, both the UEs (e.g., 210-1 and 210-2 of a dual steer device) may have URSP rules that can match a certain traffic, in addition to indicating access type preference between 3GPP or non-3GPP access. In a dual steer scenario, the techniques described herein may be implemented to enable a dual steer UE 210 to differentiate between RATs and core networks across different 3GPP access networks. As such, the techniques described herein may involve a URSP. In some implementations, this may be achieved by RAT and CN types being added to an RSD in the URSP.

URSP rule may include a rule precedence value; a traffic descriptor that determines when a rule is applicable, an RSD, and a 3GPP RAT and CN preference. The rule precedence may determine the order the URSP rule is enforced in the UE. The traffic descriptor may define types of traffic applicable to the URSP rule, the RSD may define an order in which route selection descriptors applied. The 3GPP RAT and CN preference may include a preference for 3GPP RATs and CNs in general and/or types of 3GPP RAT and CNs (e.g., E-UTRA/EPC, E-UTRA NTN/EPC, NR TN/5GC, NR NTN/5GC, PNI-NPN, etc.). The 3GPP RAT and CN preference may function as a trigger for UE 210 to apply a URSP rule to imitate traffic switching and steering across different 3GPP access networks. The URSP may also include

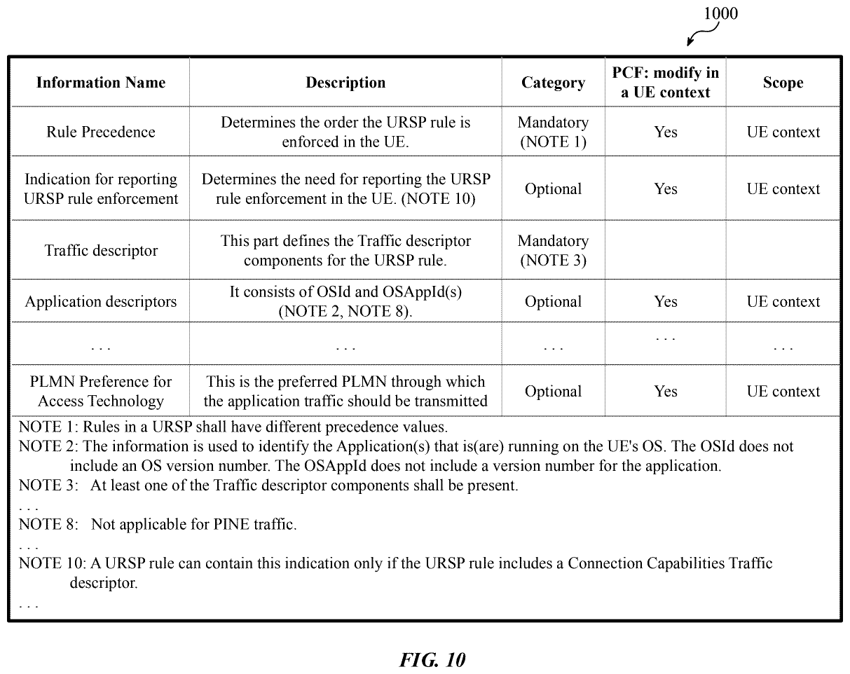

FIG. 10 is a diagram of example of a URSP rule according to one or more implementations described herein. URSP 1000 may include multiple information types or names, corresponding descriptions, categories, indication of whether PCF 440 is permitted to modify the corresponding information in a UE context, and a corresponding scope. The types of information may include a rule precedence, an indication for reporting URSP rule enforcement, a traffic descriptor, application descriptors, a PLMN preference for access technology.

As shown in FIG. 10, one or more of the techniques described herein may include a dual steer access network steering, switching policy (DSSSP) for 3GPP networks. This may help differentiate RAT and core network scenarios across different types of 3GPP access to be considered. A DSSP may include rule precedence value, a traffic descriptor that determines when the rule is applicable, a PLMN preference for type of 3GPP access technology, and a route selection descriptor that includes a 3GPP RAT type and CN combination for dual steering when the access type is 3GPP (e.g., E-UTRA/EPC, NR TN/5GC, NR NTN/5GC, PNI-NPN, etc.).

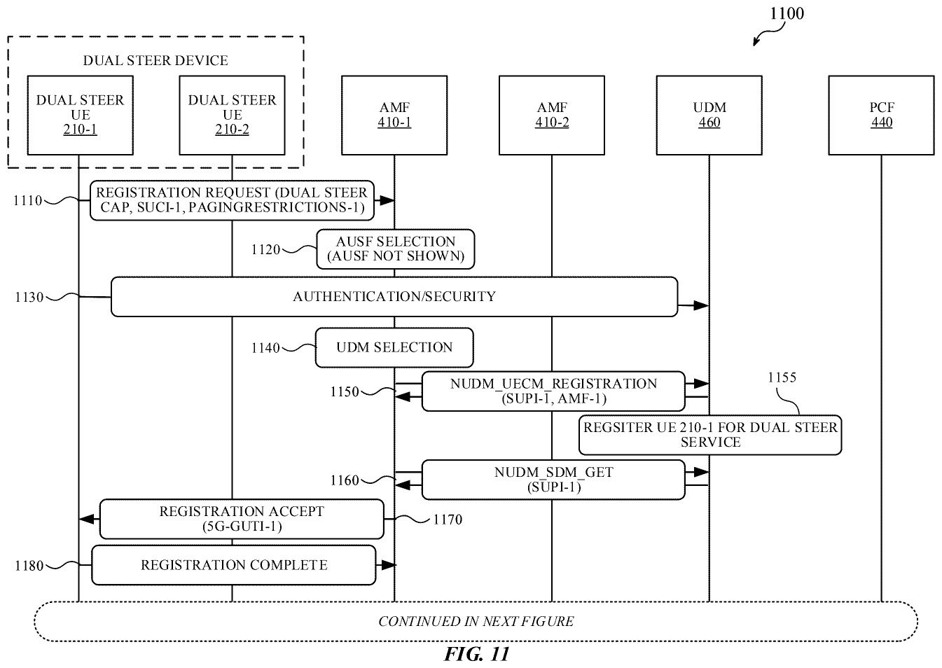

FIGS. 11-13 are diagrams of an example of a process for dual steer policy management according to one or more implementations described herein As shown, process 1100 may include a dual steer device, AMF 410-1, AMF 410-2, UDM 1160, and home PCF 440. An AUSF is referred to below but is not show. PCF 440 may be an H-PCF. In some implementations, some or all of process 1100 may be performed by one or more other systems or devices, including one or more of the devices of FIGS. 2-5. Additionally, process 1100 may include one or more fewer, additional, differently ordered and/or arranged operations than those shown in FIGS. 11-13. In some implementations, some or all of the operations of process 1100 may be performed independently, successively, simultaneously, etc., of one or more of the other operations of process 1100. As such, the techniques described herein are not limited to the number, sequence, arrangement, timing, etc., of the operations or processes depicted in FIGS. 11-13.

The dual steer device may be represented as UE 210-1 and UE 210-2 as the dual steer device may have two SUPIs (e.g., SUPI-1 and SUPI-1, respectively). As described above, a SUPI may correspond to a subscription for service registered with a 3GPP network. As such, UE 210-1 may refer to the dual steer device operating under one SUPI registered with one 3GPP network, and UE 210-2 may refer to the dual steer device operating under another SUPI of another 3GPP network.

Similarly, AMF 410-1 and AMF 410-2 may refer to AMFs of different 3GPP networks. The SUPI of UE 210-1 may correspond to the 3GPP network of AMF 410-1. The SUPI of UE 210-2 may correspond to the 3GPP network of AMF 410-2. UDM 1160 and PCF 440 may represent a PCF associated with a home PLMN (HPLMN) of the dual steer device. For purposes of explaining process 11000, assume that PCF 440 corresponds to primary or home network of the dual steer device, and that the primary home network corresponds to SUPI-1 of UE 210-1 and AMF 410-1. UE 210-2, SUPI-2, and AMF 410-2 may correspond to a secondary number of the dual steer device.

UE 210-1 may register with a first or primary 3GPP network and may perform a normal PLMN selection process to select the PLMN for registration. As shown, process 1100 may include UE 210-1 communicating a registration request to AMF 410-1 (at 1110). The registration request may include dual steer capability information, a SUPI (e.g., SUPI-1), and paging restrictions information 1. The registration request may also include an indication of primary access. The paging restrictions information 1 may related to paging signals to UE 210-1 since the network may be the primary network of UE 210-1.

The registration request indicating dual steering may inform the network that the UE is capable of dual steering and, for example, that registration and context setup for UE 210-1 may later include an additional registration and context for UE 210-2. The registration request indicating SUPI-1 may enable the receiving network to register UE 210-1 for service consistent with a subscription associated with SUPI-1. The registration request indicating primary access may cause the receiving network (e.g., AMF 410-1) to handle the request in a different manner than a request for secondary access (e.g., by obtaining steering rules and policies associated with SUPI-1 and providing the duel steering rules and policies to UE 210-1).

AMF 410-1 may select an AUSF of the core network (1120) and AMF 410-1 may communicate with the AUSF (and one more other core network entities) to authenticate credentials of UE 210-1 (at 1130). UE 210-1, AMF 410-1, and UDM 460 may communicate with one another to determine a subscription and services registered to a SUPI-1 of UE 210-1 and verify that the subscription and services includes dual steer services. This may involve AMF 410-1 selecting UDM 460 of a home network of UE 210-1 (at 1140).

AMF 410-1 may communicate with UDM 460 to create a session context for UE 210-1, which may include marking the access request and session as primary access for paging, MT calls, and other purposes. AMF 410-1 may exchange messages with UDM 460 about a NUDM_UECM registration message, which may include the SUPI-1 of UE 210-1 and an identifier of AMF 410-1 (at 1150). The NUDM_UECM registration message cause UDM 460 to register UE 210-1 of SUPI-1 for dual steer service. This may include UDM 460 creating an instance of a dual steer registration for UE 210-1. AMF 410-1 may exchange messages with UDM 460 involving a NUDM_SDM_GET message, which may include the SUPI-1 (at 1160).

AMF 410-1 may send a registration accept message to UE 210-1 (at 1170). The registration accept message may include a 5G globally unique temporary identifier (5G-GUTI) (e.g., 5G-GUTI-1) corresponding to the registration. A 5G-GUTI may include a temporary identity that does not have a fixed association with a specific subscriber or device. The use of a temporary identity may help improve privacy, and AMF 410-1 may change an allocated 5G-GUTI at any time. The registration accept message may notify UE 210-1 that the network supports dual steer functionality in general and the subscription of UE 210-1 for dual steer services. The network optionally includes list of PLMNs supported for each access technology based on the UE subscription. In some implementations, UE 210-1 may respond to the registration accept message by sending AMF 410-1 a registration complete message (at 1180).

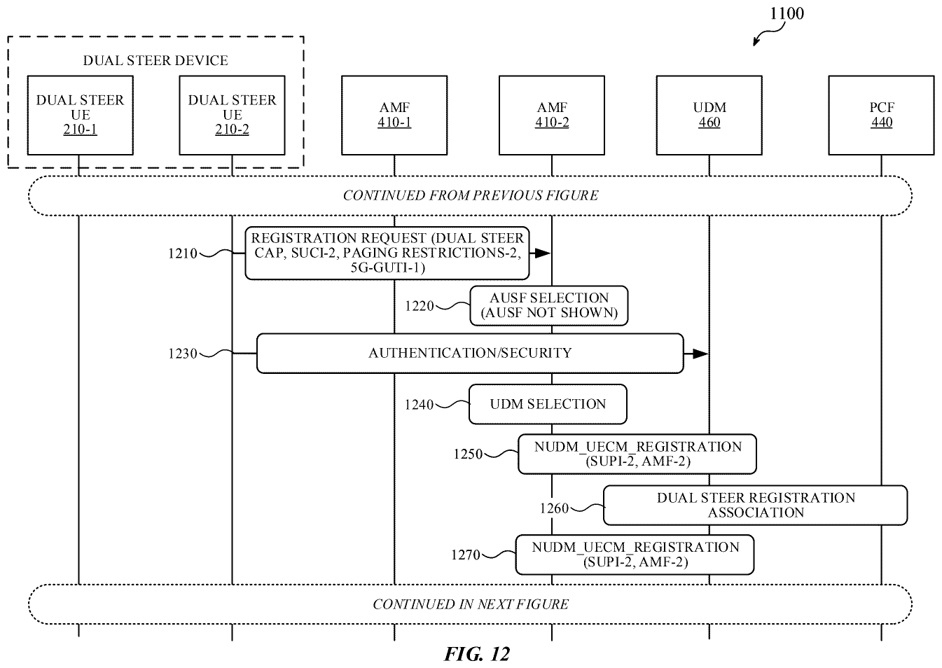

Referring to FIG. 12, process 1100 may also include UE 210-2 sending a registration request to AMF 410-2 (at 1210). For example, the dual steer device activates a new application, the device may evaluate URSP rules and select the URSP rule and RSD according to a corresponding RAT and/or CN preference that applies to traffic associated with a PDU session of the application. The dual steer device may identify an appropriate 3GPP access network (e.g., a secondary 3GPP access network of AMF 410-2) and 2 sending a registration request to AMF 410-2. The registration request may include dual steer capability information, a SUPI (e.g., SUPI-2), and paging restrictions information 1. The registration request may also include an indication of secondary access. The paging restrictions information 1 may related to paging signals to UE 210-2 since the network may be the secondar network of the dual steer device.

The registration request indicating dual steering may inform the network that the UE is capable of dual steering and, for example, that registration and context setup for UE 210-2 may later include an additional registration and context for UE 210-2. The registration request indicating SUPI-2 may enable the receiving network to register UE 210-2 for service consistent with a subscription associated with SUPI-2. The registration request indicating secondary access may cause the receiving network (e.g., AMF 410-2) to handle the request in a different manner than a request for primary access (e.g., by obtaining steering rules and policies associated with SUPI-2 and providing the duel steering rules and policies to UE 210-2).

AMF 410-2 may select an AUSF of the core network (1120) and AMF 410-2 may communicate with the AUSF (and one more other core network entities) to authenticate credentials of UE 210-2 (at 1230). UE 210-2, AMF 410-2, and UDM 460 may communicate with one another to determine a subscription and services registered to the SUPI-2 of UE 210-2 and verify that the subscription and services includes dual steer services. This may involve AMF 410-2 selecting UDM 460 of a home network of UE 210-2 (at 1240).

AMF 410-2 may communicate with UDM 460 to create a session context for UE 210-2, which may include marking the access request and session as primary access for paging, MT calls, and other purposes. AMF 410-2 may exchange messages with UDM 460 about a NUDM_UECM registration message, which may include the SUPI-1 of UE 210-1 and an identifier of AMF 410-2 (at 1250). The NUDM_UECM registration message cause UDM 460 communicate with PCF 440 to register UE 210-2 of SUPI-2 for dual steer service. UDM 460 may associate the dual steer registration of SUPI-1 and AMF 410-1 with the dual steer registration of SUPI-2 and AMF 410-2 (at 1260). This may result in UDM 460 generating a record that creates a logical association of traffic associated with UE 210-1 and UE 210-2. The record may be used by the network to monitor traffic flows, track network access, associated the traffic flows with the same IP address update dual steering policies and rules and provide them to the dual steer device, etc. AMF 410-1 may exchange messages with UDM 460 involving a NUDM_SDM_GET message, which may include the SUPI-1 (at 1160). The NUDM_SDM_GET message may be used to verify that the device supports DualSteer subscription.

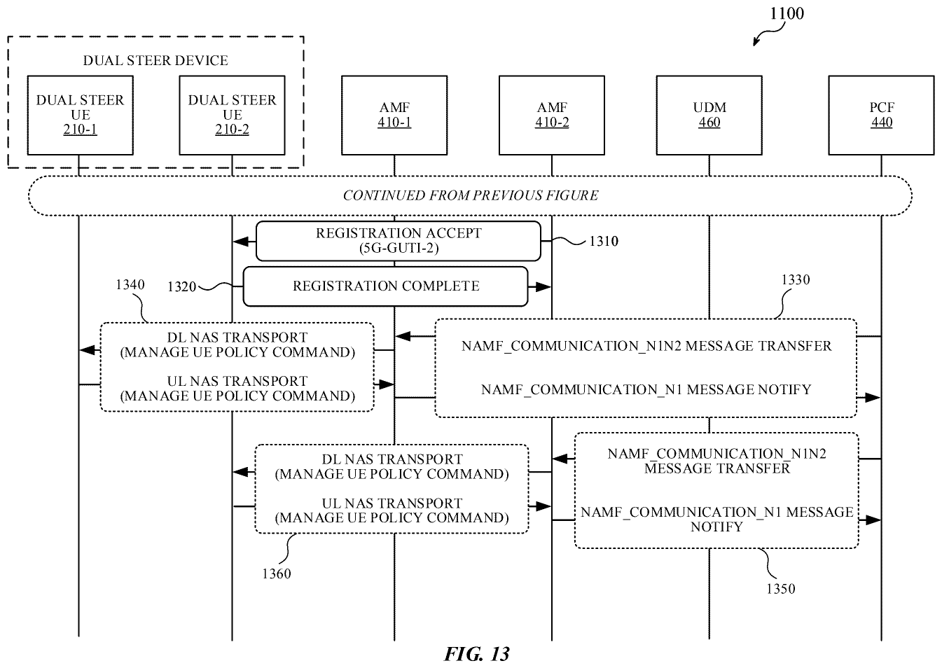

Referring to FIG. 13, AMF 410-2 may send a registration accept message to UE 210-2 (at 1310). The registration accept message may include a 5G globally unique temporary identifier (e.g., 5G-GUTI-2) corresponding to the registration. A 5G-GUTI may include a temporary identity that does not have a fixed association with a specific subscriber or device. The use of a temporary identity may help improve privacy, and AMF 410-2 may change an allocated 5G-GUTI at any time. The registration accept message may notify UE 210-2 that the network supports dual steer functionality in general and the subscription of UE 210-1 for dual steer services. In some implementations, when UE 210 is not registered with the network, AMF 410-1 may send UE 210-1 a registration rejection message, which may include an indication of whether the subscription supports dual steer service. The network optionally includes list of PLMNs supported for each access technology based on the UE subscription. In some implementations, UE 210-1 may respond to the registration accept message by sending AMF 410-1 a registration complete message (at 1320).

PCF 440 may determine URSP rules for UE 210-1 and may send the URSP rules to AMF 410-1 (e.g., via a Namf_Communication_N1N2MessageTransfer message (at 1330). The URSP rules may be applicable for dual steering relative to the home network of UE 210-1 and other networks (e.g., secondary networks) accessed by the dual steer device (e.g., via UE 210-2). In some implementations, URSP rules may be provided through only the primary access network. In such implementations, PCF 440 may be configured to reconcile and provide an appropriate set of rules for both access networks. In other implementations, URSP rules may be provided through both the primary and secondary access networks. When the dual steer device receives URSP rules from both the primary and secondary access networks, the dual steer device may use one set of URSP rules (e.g., the URSP rules from the primary network, the most recent URSP rules received, etc.).

AMF 410-1 may respond by sending the URSP rules to UE 210-1 via a DL NAS transport message (at 1340). The URSP rules may be sent as a manage UE policy command message or IE. UE 210-1 may receive the message from AMF 410-1 and respond by sending AMF 410-1 a UL NAS transport message (at 1340 also). This may include a manage UE policy complete message or IE and may include an indication or confirmation of the URSP rules having been received. AMF 410-1 may respond by sending PCF 440 a confirmation message of the URSP rules having been received (e.g., a Namf_Communication_N1N2MessageNotify message) (at 1330).

PCF 440 may determine URSP rules for UE 210-2 and may send the URSP rules to AMF 410-2 (e.g., via a Namf_Communication_N1N2MessageTransfer message (at 1350). The URSP rules may be applicable for dual steering relative to the home network of UE 210-1 and other networks (e.g., secondary networks) accessed by the dual steer device (e.g., via UE 210-2). In some implementations, URSP rules may be provided through both the primary and secondary access networks. When the dual steer device receives URSP rules from both the primary and secondary access networks, the dual steer device may use one set of URSP rules (e.g., the URSP rules from the primary network, the most recent URSP rules received, etc.).

AMF 410-2 may send the URSP rules to UE 210-2 via a DL NAS transport message (at 1356). The URSP rules may be sent as a manage UE policy command message or IE. In some implementations, the manage UE policy command message may indicate that the URSP rules previously received by UE 210-1 are also applicable to UE 210-2. UE 210-2 may receive the message from AMF 410-2 and respond by sending AMF 410-2 a UL NAS transport message (at 1360). This may include a manage UE policy complete message or IE, which may include an indication or confirmation of the URSP rules having been received. AMF 410-2 may respond by sending PCF 440 a confirmation message of the URSP rules having been received (e.g., a Namf_Communication_N1N2MessageNotify message) (at 1350).

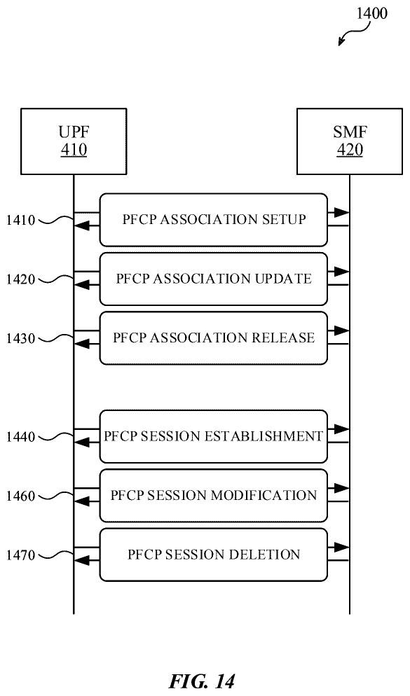

FIG. 14 is a diagram of an example of a process 1400 for session management function (SMF) and user plane function (UPF) interactions via policy function control protocol (PFCP) according to one or more implementations described herein. Session management and subscriptions may be handled by a home network. A dual steer UE 210 may have two subscriptions and SUPIs associated with one subscription profile from same operator. dual steer UE 210 may have two SUPIs (recognized as two UEs that establish independent PDU sessions via different 3GPP networks. The PDU sessions may each correspond to different application traffic that is steered and/or switched between these two PDU Sessions. The techniques described herein may include PDU session establishment, modification, and termination procedures to support dual steer for both UE and network-initiated dual steer sessions. The network may be configured to identify the PDU sessions from the two SUPIs of a dual steer UE and may authorize a request from the UE to establish a dual steer PDU session. The network may be configured to select a common PDU session anchor in the HPLMN for the two PDU sessions from the two SUPIs/UEs of a dual steer UE so as to allow routing the traffic across 3GPP accesses towards the same PDU session anchor (PSA) UPF 430 during switching. A single IP address may be assigned to the two PDU sessions based on the two SUPIs/UEs of a dual steer UE. N4 session management may be configured between the SMF 420 and UPF 430 to support the dual steer PDU sessions and subscription data to the dual steer PDU session may be provided.

As shown, process 1400 may include UPF 410 and SMF 420. In some implementations, some or all of process 1400 may be performed by one or more other systems or devices, including one or more of the devices of FIGS. 2-5. Additionally, process 1400 may include one or more fewer, additional, differently ordered and/or arranged operations than those shown in FIG. 14. In some implementations, some or all of the operations of process 1400 may be performed independently, successively, simultaneously, etc., of one or more of the other operations of process 1400. As such, the techniques described herein are not limited to the number, sequence, arrangement, timing, etc., of the operations or processes depicted in FIG. 14.

A PFCP may use the Sx/N4 interface of a core network to formalize interactions between different types of functional elements or entities of a core network (e.g., an EPC, 5GC, etc.) services to mobile subscribers. PFCP may include a control plane (CP) functional elements, handling mostly signaling procedures, and user data plane (UP) functional elements that handle traffic and packet forwarding based on rules set by the CP elements. PFCP may be used to enable and implement dual steer traffic associated with UE 210-1 via a primary network and UE 210-2 via a secondary network. UPF 410 and SMF 420 may manage how and when PFCP is implemented.

Process 1400 may include UPF 410 and SMF 420 communicating to set up a PFCP association between traffic associate with UE 210-1 via a primary 3GPP network and UE 210-2 via a secondary 3GPP network (at 1410). UPF 410 and SMF 420 may also communicate to update the PFCP association (at 1420) and to release or terminate the PFCP association (at 1430). Creating and updating the association may include generating list of optional features for dual steer capabilities and informing other network entities about the features and capabilities. For example, this may include a PFCP Association Setup procedure that may be used to setup a PFCP association between SMF 420 and UPF 410, to enable SMF 420 to use the resources of UPF 410 subsequently (e.g., establish PFCP Sessions).

The PFCP Association Update procedure may be configured to modify an existing PFCP association between SMF 420 and UPF 410. The PFCP Association Update procedure may be initiated by UPF 410 or by SMF 420 to update the supported features or available resources of UPF 410. The PFCP Association Release procedure may be used to terminate the PFCP association between SMF 420 and UPF 410 due to, for example, operation and maintenance (OAM) reasons. The PFCP Association Release Request may be initiated by SMF 420. The PFCP Session Establishment procedure shall be used to setup a PFCP session between SMF 420 and UPF 410 and configure rules in the UPF so that UPF 410 may handle incoming packets. The PFCP Session Modification procedure may be used to modify an existing PFCP session (e.g. to configure a new rule, to modify an existing rule, to delete an existing rule, etc). The PFCP Session Deletion procedure may be used to delete an existing PFCP session between SMF 420 and the UPF 410.

Process 1400 may also include UPF 410 and SMF 420 may communicate to establish a PFCP session associate with UE 210-1 via a primary 3GPP network and/or UE 210-2 via a secondary 3GPP network (at 1440). UPF 410 and SMF 420 may communicate to modify a PFCP session (1460). UPF 410 and SMF 420 may communicate to delete a PFCP session (at 1470). These procedures may be used by the CP to set up, modify, and remove sessions that sets of rules for processing and forwarding UP traffic. These may be the main functional message of the PFCP application domain. The UP may include usage report information in an answer, such that an additional session report message may be avoided.

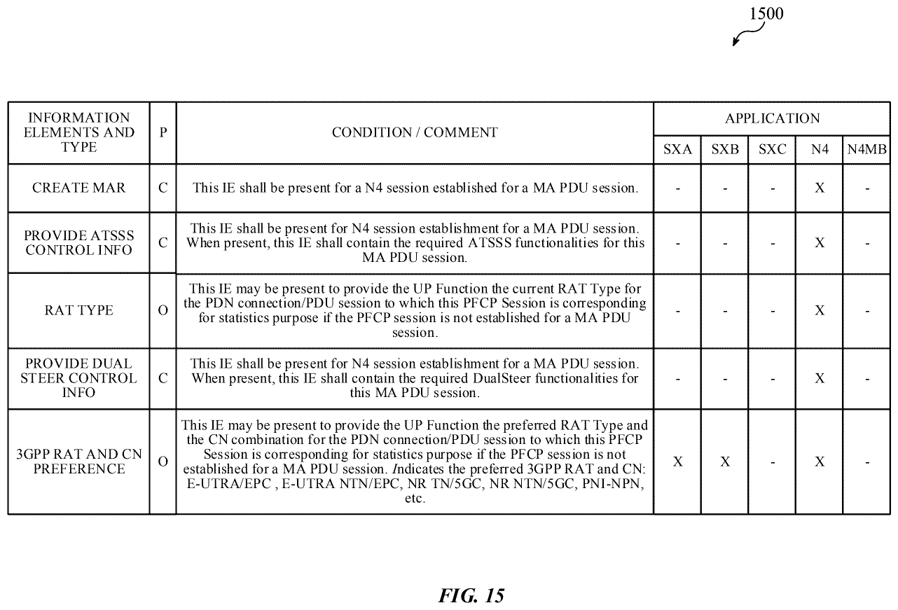

FIG. 15 is a diagram of an example 1500 of IEs of a PFCP session establishment request according to one or more implementations described herein. A PFCP session establishment request may be sent over the Sxa, Sxb, Sxc, N4 and N4mb interfaces by a CP function to establish a new PFCP session context in the UPF 430. As shown, example 1500 may include a table with columns for IE type, a column for a P/C/O value, a condition/comment, and an application type. The IE type (or IE name) may include entries for create MAR, provide DualSteer control information, RAT type, provide dual steer control information, and 3GPP RAT and CN preference.

A create a multi-access rule (MAR) ID may be configured to be presented via the CP to establish a multiple access (MA) PDU session via the N4 interface. An IE of “Provide DualSteer control information” may provide DualSteer control information for N4 interface session establishment for a MA PDU session. When Provide DualSteer control information is provided the IE may contain the 3GPP RAT and CN Preference functionalities for the MA PDU session.

An IE of 3GPP RAT and CN preference may be present to provide UPF 430 the preferred RAT Type and the CN combination for the PDN connection/PDU session to which this PFCP Session corresponds for statistics purpose (if the PFCP session is not established for a MA PDU session). The IE may indicate a preferred 3GPP RAT and CN: E-UTRA/EPC, E-UTRA NTN/EPC, NR TN/5GC, NR NTN/5GC, PNI-NPN, etc. The IE may be applicable to the N4 interface.

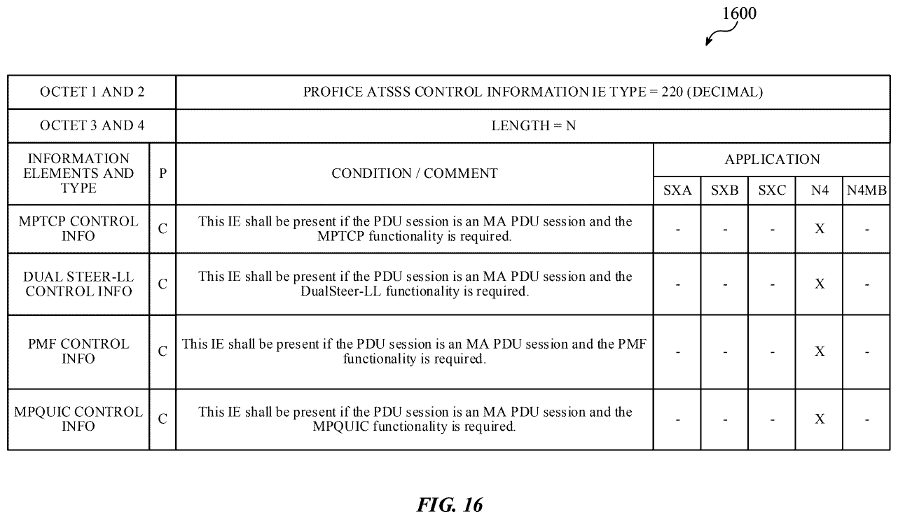

FIG. 16 is a diagram of an example 1600 of dual steer IEs of a PFCP session establishment request according to one or more implementations described herein. A PFCP session establishment request may be sent over the N4 interface by a SMF 420 to establish a new PFCP session context in the UPF 430. Example 1600 includes DualSteer control information IEs that may be within a PFCP session establishment request.

The MPTCP control information may include an IE that is present when a PDU session is an MA PDU session and MPTCP functionality is required. The dual steer LL control information may be present when the PDU session is an MA PDU session, and the DualSteer-LL functionality is required. The PMF may be present when the PDU session is an MA PDU session and the PMF functionality is required. The PMQUIC control information may be present when the PDU session is an MA PDU session and the PMQUIC functionality is required

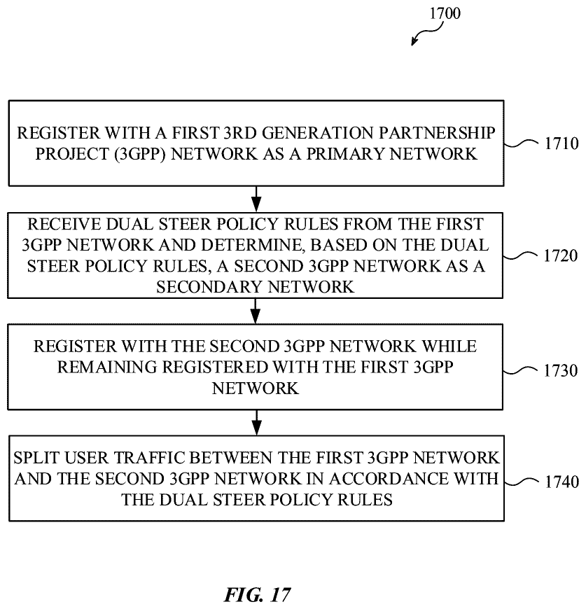

FIG. 17 is a diagram of an example process 1700 for dual steer in a wireless network according to one or more implementations described herein. Process 1700 may be implemented by one or more baseband processors and/or UE 210. In some implementations, some or all of process 1700 may be performed by one or more other systems or devices, including one or more of the devices of FIGS. 2-5. Additionally, process 1700 may include one or more fewer, additional, differently ordered and/or arranged operations than those shown in FIG. 17. In some implementations, some or all of the operations of process 1700 may be performed independently, successively, simultaneously, etc., of one or more of the other operations of process 1700. As such, the techniques described herein are not limited to a number, sequence, arrangement, timing, etc., of the operations or processes depicted in FIG. 17.

As shown, process 1700 may include registering with a first 3rd generation partnership project (3GPP) network as a primary network (block 1710). Process 1700 may also include receiving dual steer policy rules from the first 3GPP network and determining, based on the dual steer policy rules, a second 3GPP network as a secondary network (block 1720). Process 1700 may also include registering with the second 3GPP network while remaining registered with the first 3GPP network (block 1730). Process 1700 may also include splitting user traffic between the first 3GPP network and the second 3GPP network in accordance with the dual steer policy rules (block 1740). Example process 1700 may further include one or more, or any combination, of additional operations, which may be described as an aspect, feature, or example of the techniques described herein.

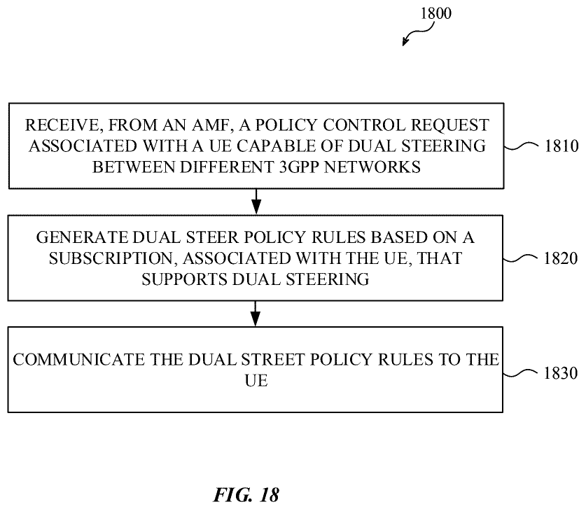

FIG. 18 is a diagram of an example process 1800 for dual steer in a wireless network according to one or more implementations described herein. Process 1800 may be implemented by base station 222. In some implementations, some or all of process 1800 may be performed by one or more other systems or devices, including one or more of the devices of FIGS. 2-5. Additionally, process 1800 may include one or more fewer, additional, differently ordered and/or arranged operations than those shown in FIG. 18. In some implementations, some or all of the operations of process 1800 may be performed independently, successively, simultaneously, etc., of one or more of the other operations of process 1800. As such, the techniques described herein are not limited to the number, sequence, arrangement, timing, etc., of the operations or processes depicted in Fig. 10.

As shown, process 1800 may include receiving, from an AMF, a policy control request associated with a UE capable of dual steering between different 3GPP networks (block 1810). Process 1800 may also include generating dual steer policy rules based on a subscription, associated with the UE, that supports dual steering (block 1820). Process 1800 may also include communicating the dual street policy rules to the UE (block 1830). Example process 1800 may further include one or more, or any combination, of additional operations, which may be described as an aspect, feature, or example of the techniques described herein.

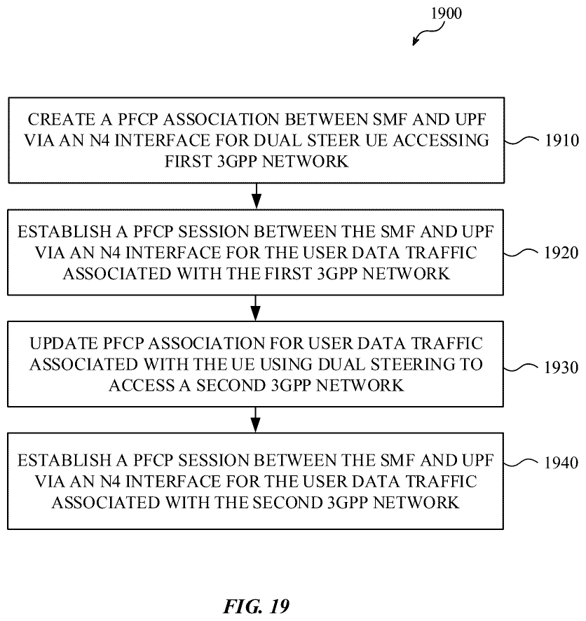

FIG. 19 is a diagram of an example process 1900 for dual steer in a wireless network according to one or more implementations described herein. Process 1900 may be implemented by AMF 410. In some implementations, some or all of process 1900 may be performed by one or more other systems or devices, including one or more of the devices of FIGS. 2-5. Additionally, process 1900 may include one or more fewer, additional, differently ordered and/or arranged operations than those shown in FIG. 19. In some implementations, some or all of the operations of process 1900 may be performed independently, successively, simultaneously, etc., of one or more of the other operations of process 1900. As such, the techniques described herein are not limited to the number, sequence, arrangement, timing, etc., of the operations or processes depicted in Fig. 10.

As shown, process 1900 may include creating a PFCP association between SMF and UPF via an N4 interface for dual steer UE accessing first 3GPP network (block 1910). Process 1900 may also include establishing a PFCP session between the SMF and UPF via an N4interface for the user data traffic associated with the first 3GPP network (block 1920). Process 1900 may also include updating PFCP association between the SMF and the UPF via the N4interface for user data traffic associated with the UE using dual steering to access a second 3GPP network different from the first 3GPP network (block 1930). Process 1900 may also include establishing a PFCP session between the SMF and UPF via an N4 interface for the user data traffic associated with the second 3GPP network (block 1940). Example process 1900 may further include one or more, or any combination, of additional operations, which may be described as an aspect, feature, or example of the techniques described herein. Example process 1900 may further include one or more, or any combination, of additional operations, which may be described as an aspect, feature, or example of the techniques described herein.

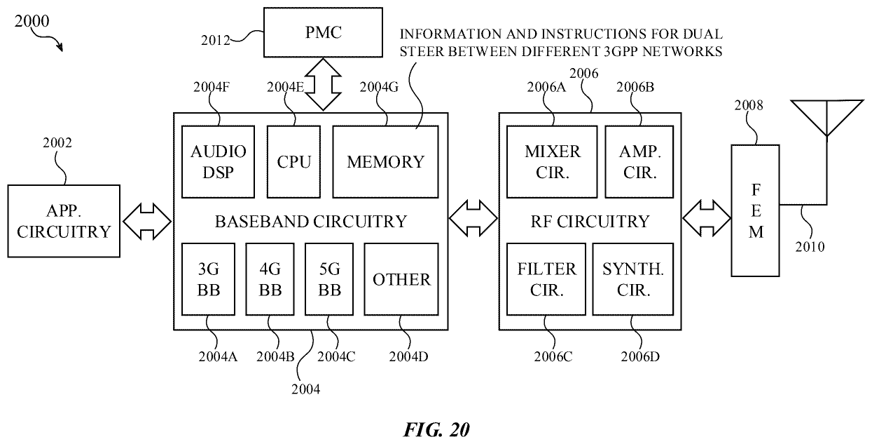

FIG. 20 is a diagram of an example of components of a device 2000 according to one or more implementations described herein. In some implementations, the device 2000 can include application circuitry 2002, baseband circuitry 2004, RF circuitry 2006, front-end module (FEM) circuitry 2008, one or more antennas 2010, and power management circuitry (PMC) 2012 coupled together at least as shown. The components of the illustrated device 2000 can be included in a UE or a RAN node. In some implementations, the device 2000 can include fewer elements (e.g., a RAN node may not utilize application circuitry 2002, and instead include a processor/controller to process IP data received from a CN or an Evolved Packet Core (EPC)). In some implementations, the device 2000 can include additional elements such as, for example, memory/storage, display, camera, sensor (including one or more temperature sensors, such as a single temperature sensor, a plurality of temperature sensors at different locations in device 2000, etc.), or input/output (I/O) interface. In other implementations, the components described below can be included in more than one device (e.g., said circuitries can be separately included in more than one device for Cloud-RAN (C-RAN) implementations).

The application circuitry 2002 can include one or more application processors. For example, the application circuitry 2002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 2000. In some implementations, processors of application circuitry 2002 can process IP data packets received from an EPC.

The baseband circuitry 2004 can include circuitry such as, but not limited to, one or more single-core or multi-core processors. The baseband circuitry 2004 can include one or more baseband processors or control logic to process baseband signals received from a receive signal path of the RF circuitry 2006 and to generate baseband signals for a transmit signal path of the RF circuitry 2006. Baseband circuity 2004 can interface with the application circuitry 2002 for generation and processing of the baseband signals and for controlling operations of the RF circuitry 2006. For example, in some implementations, the baseband circuitry 2004 can include a 3G baseband processor 2004A, a 4G baseband processor 2004B, a 5G baseband processor 2004C, or other baseband processor(s) 2004D for other existing generations, generations in development or to be developed in the future (e.g., 5G, 6G, etc.). The baseband circuitry 2004 (e.g., one or more baseband processors 2004A-D) can handle various radio control functions that enable communication with one or more radio networks via the RF circuitry 2006. In other implementations, some or all of the functionality of baseband processors 2004A-D can be included in modules stored in the memory 2004G and executed via a Central Processing Unit (CPU) 2004E. The radio control functions can include, but are not limited to, signal modulation/demodulation, encoding/decoding, radio frequency shifting, etc. In some implementations, modulation/demodulation circuitry of the baseband circuitry 2004 can include Fast-Fourier Transform (FFT), precoding, or constellation mapping/de-mapping functionality. In some implementations, encoding/decoding circuitry of the baseband circuitry 2004 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 2004G may receive and/or store information and instructions for enabling U3 210 to dual steer across different 3GPP networks. The UE may register with a first 3GPP network for dual steering and indicate a capability for dual steering. The first 3GPP network may register the UE for dual steering and provide the UE with rules and policies for dual steering. The rules and policies may be based on preferences, capabilities, and network subscriptions of U3 210. U3 210 may reregister with a second 3GPP network and indicate a capability to dual steer. The first and second 3GPP networks may coordinate to associate the duel steering registrations of U3 210 at the first and second 3GPP networks. U3 210 may proceed to engage in traffic steering and network switching based on the dual steering rules and policies. Many other aspects and examples are also described herein. Many other aspects and examples are also described herein.

In some implementations, the baseband circuitry 2004 can include one or more audio digital signal processor(s) (DSP) 2004F. The audio DSPs 2004F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 2004 and the application circuitry 2002 can be implemented together such as, for example, on a system on a chip (SOC).

In some implementations, the baseband circuitry 2004 can provide for communication compatible with one or more radio technologies. For example, in some implementations, the baseband circuitry 2004 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 2004 is configured to support radio communications of more than one wireless protocol can be referred to as multi-mode baseband circuitry.

RF circuitry 2006 can enable communication with wireless networks using modulated electromagnetic radiation through a non-solid medium. In various implementations, the RF circuitry 2006 can include switches, filters, amplifiers, etc. to facilitate the communication with the wireless network. RF circuitry 2006 can include a receive signal path which can include circuitry to down-convert RF signals received from the FEM circuitry 2008 and provide baseband signals to the baseband circuitry 2004. RF circuitry 2006 can also include a transmit signal path which can include circuitry to up-convert baseband signals provided by the baseband circuitry 2004 and provide RF output signals to the FEM circuitry 2008 for transmission.

In some implementations, the receive signal path of the RF circuitry 2006 can include mixer circuitry 2006A, amplifier circuitry 2006B and filter circuitry 2006C. In some implementations, the transmit signal path of the RF circuitry 2006 can include filter circuitry 2006C and mixer circuitry 2006A. RF circuitry 2006 can also include synthesizer circuitry 2006D for synthesizing a frequency for use by the mixer circuitry 2006A of the receive signal path and the transmit signal path. In some implementations, the mixer circuitry 2006A of the receive signal path can be configured to down-convert RF signals received from the FEM circuitry 2008 based on the synthesized frequency provided by synthesizer circuitry 2006D. The amplifier circuitry 2006B can be configured to amplify the down-converted signals and the filter circuitry 2006C can be a low-pass filter (LPF) or band-pass filter (BPF) configured to remove unwanted signals from the down-converted signals to generate output baseband signals. Output baseband signals can be provided to the baseband circuitry 2004 for further processing. In some implementations, the output baseband signals can be zero-frequency baseband signals, although this is not a requirement. In some implementations, mixer circuitry 2006A of the receive signal path can comprise passive mixers, although the scope of the implementations is not limited in this respect.

In some implementations, the mixer circuitry 2006A of the transmit signal path can be configured to up-convert input baseband signals based on the synthesized frequency provided by the synthesizer circuitry 2006D to generate RF output signals for the FEM circuitry 2008. The baseband signals can be provided by the baseband circuitry 2004 and can be filtered by filter circuitry 2006C. In some implementations, the mixer circuitry 2006A of the receive signal path and the mixer circuitry 2006A of the transmit signal path can include two or more mixers and can be arranged for quadrature down conversion and up conversion, respectively. In some implementations, the mixer circuitry 2006A of the receive signal path and the mixer circuitry 2006A of the transmit signal path can include two or more mixers and can be arranged for image rejection (e.g., Hartley image rejection). In some implementations, the mixer circuitry 2006A of the receive signal path and the mixer circuitry 2006A can be arranged for direct down conversion and direct up conversion, respectively. In some implementations, the mixer circuitry 2006A of the receive signal path and the mixer circuitry 2006A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 2006 can include analog-to-digital converter (ADC) and digital-to-analog converter (DAC) circuitry and the baseband circuitry 2004 can include a digital baseband interface to communicate with the RF circuitry 2006.

In some dual-mode implementations, a separate radio IC circuitry can be provided for processing signals for each spectrum, although the scope of the implementations is not limited in this respect. In some implementations, the synthesizer circuitry 2006D can be a fractional-N synthesizer or a fractional N/N+1 synthesizer, although the scope of the implementations is not limited in this respect as other types of frequency synthesizers can be suitable. For example, synthesizer circuitry 2006D can be a delta-sigma synthesizer, a frequency multiplier, or a synthesizer comprising a phase-locked loop with a frequency divider.

The synthesizer circuitry 2006D can be configured to synthesize an output frequency for use by the mixer circuitry 2006A of the RF circuitry 2006 based on a frequency input and a divider control input. In some implementations, the synthesizer circuitry 2006D can be a fractional N/N+1 synthesizer.

In some implementations, frequency input can be provided by a voltage-controlled oscillator (VCO), although that is not a requirement. Divider control input can be provided by either the baseband circuitry 2004 or the applications circuitry 2002 depending on the desired output frequency. In some implementations, a divider control input (e.g., N) can be determined from a look-up table based on a channel indicated by the applications circuitry 2002.

Synthesizer circuitry 2006D of the RF circuitry 2006 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 2006D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 2006 can include an IQ/polar converter.

FEM circuitry 2008 can include a receive signal path which can include circuitry configured to operate on RF signals received from one or more antennas 2010, amplify the received signals and provide the amplified versions of the received signals to the RF circuitry 2006 for further processing. FEM circuitry 2008 can also include a transmit signal path which can include circuitry configured to amplify signals for transmission provided by the RF circuitry 2006 for transmission by one or more of the one or more antennas 2010. In various implementations, the amplification through the transmit or receive signal paths can be done solely in the RF circuitry 2006, solely in the FEM circuitry 2008, or in both the RF circuitry 2006 and the FEM circuitry 2008.

In some implementations, the FEM circuitry 2008 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 2006). The transmit signal path of the FEM circuitry 2008 can include a power amplifier (PA) to amplify input RF signals (e.g., provided by RF circuitry 2006), and one or more filters to generate RF signals for subsequent transmission (e.g., by one or more of the one or more antennas 2010).

In some implementations, the PMC 2012 can manage power provided to the baseband circuitry 2004. In particular, the PMC 2012 can control power-source selection, voltage scaling, battery charging, or DC-to-DC conversion. The PMC 2012 can often be included when the device 2000 is capable of being powered by a battery, for example, when the device is included in a UE. The PMC 2012 can increase the power conversion efficiency while providing desirable implementation size and heat dissipation characteristics.

While FIG. 20 shows the PMC 2012 coupled only with the baseband circuitry 2004. However, in other implementations, the PMC 2012 may be additionally or alternatively coupled with, and perform similar power management operations for, other components such as, but not limited to, application circuitry 2002, RF circuitry 2006, or FEM circuitry 2008.

In some implementations, the PMC 2012 can control, or otherwise be part of, various power saving mechanisms of the device 2000. For example, if the device 2000 is in an RRC_Connected state, where it is still connected to the RAN node as it expects to receive traffic shortly, then it can enter a state known as Discontinuous Reception Mode (DRX) after a period of inactivity. During this state, the device 2000 can power down for brief intervals of time and thus save power.

If there is no data traffic activity for an extended period of time, then the device 2000 can transition off to an RRC_Idle state, where it disconnects from the network and does not perform operations such as channel quality feedback, handover, etc. The device 2000 goes into a very low power state and it performs paging where again it periodically wakes up to listen to the network and then powers down again. The device 2000 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 2002 and processors of the baseband circuitry 2004 can be used to execute elements of one or more instances of a protocol stack. For example, processors of the baseband circuitry 2004, alone or in combination, can be used execute Layer 3,Layer 2, or Layer 1 functionality, while processors of the baseband circuitry 2004 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

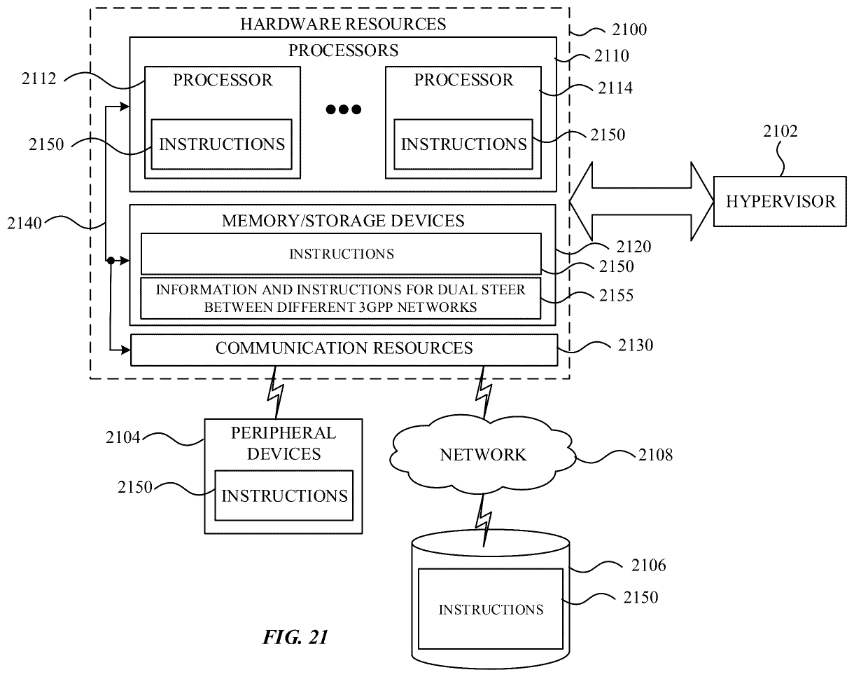

FIG. 21 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 21 shows a diagrammatic representation of hardware resources 2100 including one or more processors (or processor cores) 2110, one or more memory/storage devices 2120, and one or more communication resources 2130, each of which may be communicatively coupled via a bus 2140. For implementations where node virtualization (e.g., NFV) is utilized, a hypervisor may be executed to provide an execution environment for one or more network slices/sub-slices to utilize the hardware resources 2100.

The processors 2110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 2112 and a processor 2114.

The memory/storage devices 2120 may include main memory, disk storage, or any suitable combination thereof. The memory/storage devices 2120 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 2120 receive and/or store information and instructions 2155 for enabling UE 210 to dual steer across different 3GPP networks. The UE may register with a first 3GPP network for dual steering and indicate a capability for dual steering. The first 3GPP network may register the UE for dual steering and provide the UE with rules and policies for dual steering. The rules and policies may be based on preferences, capabilities, and network subscriptions of UE 210. UE 210 may reregister with a second 3GPP network and indicate a capability to dual steer. The first and second 3GPP networks may coordinate to associate the duel steering registrations of UE 210 at the first and second 3GPP networks. UE 210 may proceed to engage in traffic steering and network switching based on the dual steering rules and policies. Many other aspects and examples are also described herein.

The communication resources 2130 may include interconnection or network interface components or other suitable devices to communicate with one or more peripheral devices 2104 or one or more databases 2106 via a network 2108. For example, the communication resources 2130 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 2150 may comprise software, a program, an application, an applet, an app, or other executable code for causing at least any of the processors 2110 to perform any one or more of the methodologies discussed herein. The instructions 2150 may reside, completely or partially, within at least one of the processors 2110 (e.g., within the processor's cache memory), the memory/storage devices 2120, or any suitable combination thereof. Furthermore, any portion of the instructions 2150 may be transferred to the hardware resources 2100 from any combination of the peripheral devices 2104 or the databases 2106. Accordingly, the memory of processors 2110, the memory/storage devices 2120, the peripheral devices 2104, and the databases 2106 are examples of computer-readable and machine-readable media.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a DualSteer device may comprise a memory; and one or more processors configured to, when executing instructions stored in the memory, cause the one or more processors to cause the DualSteer device to: register with a first 3rd generation partnership project (3GPP) network as a primary network; receive dual steer policy rules from the first 3GPP network; determine, based on the dual steer policy rules, a second 3GPP network as a secondary network; register with the second 3GPP network while remaining registered with the first 3GPP network; and steer and switch user traffic between the first 3GPP network and the second 3GPP network in accordance with the dual steer policy rules.

In example 2, which may also include one or more of the examples described herein, a first subscription permanent identifier (SUPI) is used to register with the first 3GPP network and a second SUPI that is different than the first SUPI, is used to register with the second 3GPP network.

In example 3, which may also include one or more of the examples described herein, the one or more processors configured to: communicate, via the RF circuitry, dual steer capability information to an access and mobility management function (AMF) of the first 3GPP network; and communicate, via the RF circuitry, dual steer capability information to an AMF of the second 3GPP network.

In example 4, which may also include one or more of the examples described herein, the one or more processors configured to: communicate, via the RF circuitry and to an access and mobility management function (AMF) of the first 3GPP network, an indication that the first 3GPP network comprises a primary network; and communicate, via the RF circuitry and to an AMF of the first 3GPP network, an indication that the second 3GPP network comprises a secondary network.

In example 5, which may also include one or more of the examples described herein, a first globally unique temporary identifier (GUTI) is received for registering with the first 3GPP network, and a second GUTI is received for registering with the second 3GPP network, the first GUTI being different than the second GUTI.

In example 6, which may also include one or more of the examples described herein, the dual steer policy comprises a user equipment (UE) route selection policy (URSP) received from a policy control function (PCF) of the first 3GPP network.

In example 7, which may also include one or more of the examples described herein, the dual steer policy comprises control information for access traffic steering and switching between multiple 3GPP networks.

In example 8, which may also include one or more of the examples described herein, the URSP comprise a route selection descriptor (RSD) comprising at least one of: 3GPP radio access technology (RAT) RAT and core network (CN) preference, or public land mobile network (PLMN) preference information for access technology.

In example 9, which may also include one or more of the examples described herein, the one or more processors configured to: communicate with the first 3GPP network via a first protocol data unit (PDU) sessions; and communicate with the second 3GPP network via a second PDU sessions that is different than the first PDU session.

In example 10, which may also include one or more of the examples described herein, one or more server devices, implementing a policy control function (PCF), the one or more server devices may comprise: a memory; and one or more processors configured to, when executing instructions stored in the memory, cause the one or more processors to cause the one or more server devices to: receive, from an access and mobility management function (AMF), a policy control request associated with a user equipment (UE) of a dual steer device capable of dual steering between different 3rd generation partnership project (3GPP) networks; generate dual steer policy rules based on a subscription, associated with the UE of the dual steer device, that supports dual steering; and communicate the dual street policy rules to the UE.

In example 11, which may also include one or more of the examples described herein, the PCF comprises a home PCF (H-PCF) of the UE.

In example 12, which may also include one or more of the examples described herein, the wherein the one or more processors is configured to communicate the dual street policy rules to the UE via an access and mobility management function (AMF) corresponding to a primary network of the UE.

In example 13, which may also include one or more of the examples described herein, the one or more processors is configured to communicate the dual street policy rules to the UE via an access and mobility management function (AMF) corresponding to a secondary network of the UE.

In example 14, which may also include one or more of the examples described herein, the dual steer policy rules comprise a UE route selection policy (URSP).

In example 15, which may also include one or more of the examples described herein, the dual steer policy comprises control information for access traffic steering and switching between multiple 3GPP networks.

In example 16, which may also include one or more of the examples described herein, the URSP comprise a route selection descriptor (RSD) comprising at least one of: 3GPP radio access technology (RAT) RAT and core network (CN) preference, or public land mobile network (PLMN) preference information for access technology.

In example 17, which may also include one or more of the examples described herein, a method, performed by a DualSteer device, the method may comprise: registering a user equipment (UE) with a first 3rd generation partnership project (3GPP) network as a primary network; receiving dual steer policy rules from the first 3GPP network; determining, based on the dual steer policy rules, a second 3GPP network as a secondary network; registering another user equipment (UE) with the second 3GPP network while remaining registered with the first 3GPP network; and steering and switching user traffic between the first 3GPP network and the second 3GPP network in accordance with the dual steer policy rules.

In example 18, which may also include one or more of the examples described herein, a method, performed by one or more server devices, implementing a policy control function (PCF), the method comprising: receive, from an access and mobility management function (AMF), a policy control request associated with a user equipment (UE) of a dual steer device capable of dual steering between different 3rd generation partnership project (3GPP) networks; generate dual steer policy rules based on a subscription, associated with the UE of the dual steer device, that supports dual steering; and communicate the dual street policy rules to the UE.

In example 19, which may also include one or more of the examples described herein, one or more server devices, implementing a session management function (SMF) and a user plane function (UPF), the one or more server devices comprising: a memory; and one or more processors configured to, when executing instructions stored in the memory, cause the one or more processors to cause the one or more server devices to: create a policy function control protocol (PFCP) association between the SMF and UPF via an N4 interface for user data traffic associated with a user equipment (UE) of a dual steer device capable of dual steering accessing a first 3rd generation partnership project (3GPP) network; and update a PFCP association between the SMF and the UPF via the N4 interface for user data traffic associated with another UE of a dual steer device using dual steering to access a second 3GPP network different from the first 3GPP network.

In example 20, which may also include one or more of the examples described herein, the one or more processors are further configured to: establish a PFCP session between the SMF and UPF via an N4 interface for the user data traffic associated with the first 3GPP network.

In example 21, which may also include one or more of the examples described herein, the one or more processors are further configured to: establish a PFCP session between the SMF and UPF via another N4 interface for the user data traffic associated with the second 3GPP network.

In example 22, which may also include one or more of the examples described herein, the PFCP session is used to provide DualSteer control information to the UPF.

In example 23, which may also include one or more of the examples described herein, the DualSteer control information comprises a 3GPP radio access technology (RAT) and core network (CN) preference.

In example 24, which may also include one or more of the examples described herein, the 3GPP RAT and CN comprise at least one of: an evolved universal terrestrial radio access (E-UTRA) and Evolved Packet Core (EPC), a non-terrestrial network (NTN) E-UTRA and an EPC, a new radio (NR) terrestrial network (TN) and 5G core network (3GC), a new radio (NR) NTN and 5GC, or a public network integrated (PNI) non-public network (NPN) (PNI-NPN).

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A DualSteer device, comprising:
a memory; and
one or more processors configured to, when executing instructions stored in the memory, cause the one or more processors to cause the DualSteer device to:
register with a first 3rd generation partnership project (3GPP) network as a primary network;
receive dual steer policy rules from the first 3GPP network;
determine, based on the dual steer policy rules, a second 3GPP network as a secondary network;
register with the second 3GPP network while remaining registered with the first 3GPP network; and
steer user traffic between the first 3GPP network and the second 3GPP network in accordance with the dual steer policy rules.

2. The DualSteer device of claim 1, wherein a first subscription permanent identifier (SUPI) is used to register with the first 3GPP network and a second SUPI that is different than the first SUPI, is used to register with the second 3GPP network.

3. The DualSteer device of claim 1, wherein the one or more processors configured to:
communicate, via the RF circuitry, dual steer capability information to an access and mobility management function (AMF) of the first 3GPP network; and
communicate, via the RF circuitry, dual steer capability information to an AMF of the second 3GPP network.

4. The DualSteer device of claim 1, wherein the one or more processors configured to:
communicate, via the RF circuitry and to an access and mobility management function (AMF) of the first 3GPP network, an indication that the first 3GPP network comprises a primary network; and
communicate, via the RF circuitry and to an AMF of the first 3GPP network, an indication that the second 3GPP network comprises a secondary network.

5. The DualSteer device of claim 1, wherein a first globally unique temporary identifier (GUTI) is received for registering with the first 3GPP network, and a second GUTI is received for registering with the second 3GPP network, the first GUTI being different than the second GUTI.

6. The DualSteer device of claim 1, wherein the dual steer policy comprises a user equipment (UE) route selection policy (URSP) received from a policy control function (PCF) of the first 3GPP network.

7. The DualSteer device of claim 6, wherein the dual steer policy comprises control information for access traffic steering between multiple 3GPP networks.

8. The DualSteer device of claim 6, wherein the URSP comprise a route selection descriptor (RSD) comprising at least one of:
3GPP radio access technology (RAT) RAT and core network (CN) preference, or
public land mobile network (PLMN) preference information for access technology.

9. The DualSteer device of claim 1, wherein the one or more processors configured to:
communicate with the first 3GPP network via a first protocol data unit (PDU) sessions; and
communicate with the second 3GPP network via a second PDU sessions that is different than the first PDU session.

10. One or more server devices, implementing a policy control function (PCF), the one or more server devices comprising:
a memory; and
one or more processors configured to, when executing instructions stored in the memory, cause the one or more processors to cause the one or more server devices to:
receive, from an access and mobility management function (AMF), a policy control request associated with a user equipment (UE) of a dual steer device capable of dual steering between different 3rd generation partnership project (3GPP) networks;
generate dual steer policy rules based on a subscription, associated with the UE of the dual steer device, that supports dual steering; and
communicate the dual street policy rules to the UE.

11. The one or more server devices of claim 10, wherein the PCF comprises a home PCF (H-PCF) of the UE.

12. The one or more server devices of claim 10, wherein the wherein the one or more processors is configured to communicate the dual street policy rules to the UE via an access and mobility management function (AMF) corresponding to a primary network of the UE.

13. The one or more server devices of claim 10, wherein the one or more processors is configured to communicate the dual street policy rules to the UE via an access and mobility management function (AMF) corresponding to a secondary network of the UE.

14. The one or more server devices of claim 10, wherein the dual steer policy rules comprise a UE route selection policy (URSP).

15. The one or more server devices of claim 14, wherein the dual steer policy comprises control information for access traffic steering between multiple 3GPP networks.

16. The one or more server devices of claim 14, wherein the URSP comprise a route selection descriptor (RSD) comprising at least one of:
3GPP radio access technology (RAT) RAT and core network (CN) preference, or
public land mobile network (PLMN) preference information for access technology.

17. One or more server devices, implementing a session management function (SMF) and a user plane function (UPF), the one or more server devices comprising:
a memory; and
one or more processors configured to, when executing instructions stored in the memory, cause the one or more processors to cause the one or more server devices to:
create a policy function control protocol (PFCP) association between the SMF and UPF via an N4 interface for user data traffic associated with a user equipment (UE) of a dual steer device capable of dual steering accessing a first 3rd generation partnership project (3GPP) network; and
update a PFCP association between the SMF and the UPF via the N4 interface for user data traffic associated with another UE of a dual steer device using dual steering to access a second 3GPP network different from the first 3GPP network.

18. The one or more server devices of claim 17, wherein the one or more processors are further configured to:
establish a PFCP session between the SMF and UPF via an N4 interface for the user data traffic associated with the first 3GPP network.

19. The one or more server devices of claim 18, wherein the one or more processors are further configured to:
establish a PFCP session between the SMF and UPF via another N4 interface for the user data traffic associated with the second 3GPP network.

20. The one or more server devices of claim 18, wherein the PFCP session is used to provide DualSteer control information to the UPF.
